(19) United States
(12) Patent Application Publication
(10) Pub. No.: US 2002/0107824 A1
(43) Pub. Date: Aug. 8, 2002

(54) System and method of decision making

(76) Inventor: Sajid Ahmed, La Canada, CA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 09/757,015

(22) Filed: Jan. 8, 2001

Related U.S. Application Data
(60) Provisional application No. 60/175,106, filed on Jan. 6, 2000.

(51) Int. Cl. G06F 17/00

(52) U.S. Cl. 706/46

(57) ABSTRACT

The present invention relates to information systems theories and expert systems theories. The present invention provides a process, apparatus and method for decision making, based on emulation of the human decision-making process using expert-generated primary bias values, wherein a primary bias value associates a particular alternative possibility of a possibility set with a particular query, and reflects the expert's conception of the relative degree of predictive value of the query for the particular alternative relative to other alternatives in the possibility set. In particular embodiments, the present invention provides a process, apparatus and method for providing a medical diagnosis or medical self-assessment.

### CROSS-REFERENCE TO RELATED APPLICATIONS

This application claims priority from, U.S. Provisional Patent Application Serial No. 60/175,106, filed Jan. 6, 2000.

### FIELD OF THE INVENTION

The present invention relates to information systems theories and expert systems theories. The present invention provides a process, apparatus and method for decision making, based on emulation of the human decision-making process. In particular embodiments, the present invention provides a process, apparatus and a method for providing a medical diagnosis.

### BACKGROUND

Efficient, cost-effective human decision making, comprising ranking possibilities among a set of alternative possibilities, is regarded by many to be a necessary facet of modern life. Unfortunately, human decision-making is sometimes flawed, departing from reasonable objectivity. Such flaws include, for example, poor framing, recency effects, primacy effects, poor probability estimation, overconfidence, escalation phenomena, association bias and “groupthink.”

Framing effects occur where a decision among alternative possibilities, by equivalent groups of decision makers having the same information, differs because of the language or context used to present the alternate possibilities. Recency or availability effects occur where human decision among alternative possibilities is biased by information seen most recently or in a relatively available form. Primacy effects, or anchoring effects, reflect the fact that once people develop an opinion about something, or a frame of reference for analyzing an issue, it is often difficult for them to move from that position. Biased probability estimation results when people overestimate the probability of events relative to others, because these events are familiar, dramatic, under their control, or are beneficial to them, and greatly underestimate the probability of negative events. Overconfidence occurs where decision makers are overconfident about the accuracy or relevance of what they know, perhaps favoring supporting facts and ignoring contrary ones. Escalation phenomena occur where decision makers are reluctant to abandon a course of action that has already been adopted, and ignore negative indicators. Association bias occurs where decision makers are biased by past successes, and choose strategies more related or appropriate to a past situation than the current one. Groupthink reflects the tendency of human groups to maintain consensus and cohesiveness, perhaps at the expense of making the best decision. Groupthink describes what happens when the need to maintain cohesiveness overpowers the group's desire to make the best decision.

Knowledge-based systems; the use of information systems, or expert systems. Expert systems, often called knowledge-based systems, typically represent knowledge in an explicit form so that it can be used in a problem solving or decision-making process. Few such systems are designed specifically to counter the above-identified flaws in decisions making. Nonetheless, recognizing these common problems helps in understanding what information system can and cannot do for us.

An expert system is basically a collection of if-then rules, which can provide the user with an explanation of how it got to the results. It allows easy modification of knowledge, because the rules can be added easily without many additional modifications. The knowledge is explicitly stored and comprehensively coded. The knowledge base must be carefully assembled to preclude conflicting knowledge. FIG. 1 shows the basic structure of an expert system.

Knowledge-Based systems have seen use in classification, diagnosis, interpretation, monitoring, planning, prognosis and combinations thereof. There are many example of existing software that encapsulate expert systems and knowledge-based systems. One such software example is CLIPS™, which is a productive development and delivery expert system tool that provides a complete environment for the construction of rule- and/or object-based expert systems. CLIPS™ is being used by numerous users throughout the public and private community including all NASA sites and branches of the military, numerous federal bureaus, government contractors, universities, and many companies. FIG. 1 shows the knowledge-based systems environment that CLIPS™ is based on.

Representing knowledge and creating ways for people or computers to use knowledge remains a major research topic, and there are many ways to use and structure knowledge and information technology to improve the efficiency and accuracy of human decision making. Two of the many possible ways to represent knowledge are if-then rules and frames. If-then rules focus on the logic of making inferences. Frames focus on the important characteristics of situations.

If-then rules are the most common way to represent knowledge in knowledge-based systems. Essentially, an if-then rule provides that if certain conditions are true, then certain conclusions should be drawn. Traditional decision trees capture knowledge in the form of related collections of many, perhaps thousands, of if-then rules. A knowledge-based system that uses if-then rules starts with a list of facts about a particular situation. It then uses rules to draw conclusions or take actions based on these facts. These conclusions or actions create other facts. These additional facts are added to the list of current facts, and the system continues using the rules to draw additional conclusions and take additional action. Some systems also use the facts and rules to decide what additional questions to ask. For example, a medical diagnosis system might look at its current set of facts, draw a tentative conclusion, and ask additional questions that would confirm of disconfirm that conclusion.

For example, consider the following if-then rule from MYCIN™ (“Decisions Support, Expert Systems,” fourth addition, Efraib Turban, p.510, 1994), a knowledge-based system for assisting in diagnosing infectious diseases: if the stain of the organism is gram-positive, its morphology is “coccus,” and its growth conformation is chains, then there is suggestive evidence (0.7) that the identity of the organism is streptococcus.

In addition to containing conditions and conclusions, this rule from MYCIN™ contains a certainty factor (0.7), indicating the extent to which the conclusion is likely be uncertain. Knowledge-based systems for assisting experts often include uncertainty of this type because uncertainty is inherent in much of the work experts do.

Belief networks. Another way to create an expert system is through a belief network. A belief network is basically a decision support system, based on probability distributions. FIG. 2 shows a belief network. A belief network is expressed as an a cyclic directed graph where the variables, X₁, X₂, and X₃ correspond to nodes and the relationships between the nodes correspond to arcs. Associated with each variable in a belief network are probability distributions.

Imposition of structure to the decision-making process. Much of an information system's impact on improved decision making is determined by the extent to which it imposes structure on decisions or other tasks. An information system imposes a small degree of structure where it provides tools or information a person can use but does not dictate how the tools or information should be used in making the decision. More structure is imparted where the system enforces rules and procedures, but still permits the decision-maker some leeway in the overall process. The most structure is imposed when the system functions to completely automate the decision-making process. Structuring decisions appropriately is important because imposing too little structure or too much can reduce decision quality.

Treatment of uncertainty; limitations of certainty factors. Knowledge, in many instances, is indefinite, involving possibilities or probabilities rather than certainties. For example, a set of medically-related symptoms including, e.g., severe pain in the lower right side of the abdomen, point to a diagnosis of appendicitis. However, these same symptoms may relate to other diagnoses. Likewise, seismic survey results (e.g., for oil exploration) can relate to many different types of underground formations and phenomena.

To process alternative possibilities, an expert system must be able to draw conclusions about the relative likelihood of different conclusions based on the facts. Accurately determining the relative likelihood of alternative possibilities is crucial in many situations. For example, in a case in which symptoms could suggest either a bad cold or meningitis, a diagnosis with probabilities of 70 and 0.00001 percent, respectively, is different from a diagnosis with the probabilities of 70 and 15 percent. In the latter case, the doctor might well prescribe drugs for meningitis because the risk and consequences of making a mistake are too great, even if a bad cold is the most likely illness.

The treatment of uncertainty in expert systems raises many issues, starting with how to describe uncertainty. Many expert systems use certainty factors that describe the likelihood of a rule's conclusion given that its premises are true. For example, if certainty factors go from 0 to 1 in a particular system, a certainty factor of 0.5 on a rule would say that the conclusion is true about half the time.

An inherent limitation in the use of certainty factors to process indefinite information is the effective combining of certainty factors from separate inferences. For example, in a medical situation where both symptoms A and B are observed, and where symptoms A and B are linked to meningitis 45 and 75 percent of the time, respectively, what is the probability of meningitis? In some cases, the two symptoms might be independent; in others, they might be mutually reinforcing; in yet others, they might be somewhat contradictory. The effective handling of uncertainty using certainty factors is limited because there are no foolproof ways of combining certainty factors.

Fuzzy logic. The term fuzzy logic (“FL”) is currently used in a number of different senses, and often refers to anything that has to do with fuzzy set theory and its implications. Fuzzy logic is typically used in situations where data and functional relationships cannot be expressed in clear mathematical terms. Instead, “fuzzy” relational equations are applied in which quantifiers such as “for many” or “for a few” are used to relate elements of different sets. Fuzzy logic systems provide conceptual advantages, but require both intuition and experience in the proper design of working applications, such as in medical diagnosis systems.

A fuzzy set is a set with smooth, unclear boundaries (see Table I, below). Unlike an ordinary set, which admits only complete membership (1) or complete non-membership (0) of its elements to the set, membership in a fuzzy set can be valued between 0 and 1. Typical examples of such incomplete membership include “good takeoff performance,” “low fuel consumption,” or “expensive technology.” “Good takeoff performance” is neither perfect takeoff performance (1) nor zero takeoff performance (0); the “good takeoff performance” is fuzzy, somewhere between zero and one.

TABLE I

| | CRISP | FUZZY |
|---|---|---|
| Jim (6′6″) is tall | 1 | .95 |
| Jon (6′2″) is tall | 1 | .8 |
| Tom (5′11″) is tall | 1 | .6 |
| Bob (5′9″) is tall | 0 | .4 |
| Bill (5′6″) is tall | 0 | .2 |

The primary applications of fuzzy logic can be subcategorized into at least four different facets (“Fuzzy Logic,” Daniel McNeil & Paul Freiberger, 1992). The logical facet, L, refers to a logic system that includes two-valued systems with multiple-valued systems as special cases. It is applied in knowledge representation and inference from information that is imprecise, incomplete, uncertain or partially true. The set-theoretic facet, S, is concerned with classes or sets whose boundaries are not sharply defined. Many of the initial work in the field of fuzzy logic concentrated on this facet. The relational facet, R, deals with the representation and manipulation of imprecisely defined functions and relations, which is of importance in FL applications to systems analysis and control. Three basic concepts in this facet include linguistic variables, fuzzy if-then rules and fuzzy graphs. This facet also provides a foundation for the FL-based methodology of computing with words (CW). The epistemic facet, E, is linked to the logical facet and focuses on FL applications to knowledge representation, information systems, fuzzy databases, and the theories of probability and possibility. Another particularly important application area is the conception and design of information/intelligent systems.

Limitations of existing knowledge-based or expert systems. The term expert system implicates a knowledge-based system (e.g., a computer system) that will operate as well as a human expert. Realistically, however, there are fundamental differences between what a human expert can do and what an expert system can do.

Conventional computer-aided data processing techniques, such as linear regression, are difficult to implement successfully without well-defined relationships between the inputs (e.g., monitored values) and the outputs (e.g., patient condition). However, such well-defined relationships are seldom available. This is especially true, for example, in the medical area, where conditions share common symptoms, and are therefore difficult to detect and classify.

Expert systems provide a method to model complex systems using a set of production rules (i.e., if-then rules). Their current popularity lies in their design simplicity, and, to some extent, in their capability to recommend actions by inference or search. They have been shown to be beneficial, for example, in diagnosis problems under certain circumstances. However, the rule-based approach used in existing systems (even those employing fuzzy rules), requires a complete understanding of the task to be automated before the expert system can be implemented. Moreover, the large number of production rules required for increased robustness in the modeling of complex systems often slows down the decision-making process, and presents a maintenance burden due to the sheer number of rules to be coordinated.

Artificial neural networks (“neural networks”) are networks of neuron-like units that can modify themselves by adapting to changing conditions. Unlike traditional artificial intelligence systems (such as existing expert systems) which are rule-based, neural networks are very flexible and provide the capability of simulating complex nonlinear systems, the behavior of which is not well understood. Generally, neural network-based methods attempt to mimic the ability of the human brain to recognize recurring patterns on the basis of an inventory of previously learned patterns. In particular, they attempt predict the value of an output variable based on input from several other input variables that can impact it. The prediction is made by selecting from a set of known patterns the one that appears most relevant in a particular situation. Neural network-based methods have been widely used in the medical practice, because of their flexibility in modeling complex systems.

However, existing neural network-based methods address the diagnosis problem as a “black box” solution. Given a set of input parameters, they generate a single score (i.e., an estimate of the likelihood of the patient's condition), but lack any interpretive facility. In particular, they provide no further information to assist the physician in positively affecting the patient's condition. Notably missing from existing neural network-based systems is the capability to identify factors, which were critical in the diagnosis of the patient's medical condition. Such systems provide little basis for consensus with the physician's opinion and findings, because only a single score, without further explanation, is provided. The level of accuracy is also limited to the context of the disease or condition being tested for.

Limitations of Medical expert systems. As an expert system, the task of medical diagnosis can be decomposed into three basic steps: detection; classification; and recommendation. Detection refers to the step in which symptoms associated with one or more specific illnesses or conditions are first recognized. Classification is the process of designating or naming the condition, for instance, categorizing the condition into a known diagnostic group. Recommendation is the step in which the physician prescribes a course of treatment for the condition.

Various problems are often encountered when performing one or more of these diagnosis steps in a typical clinical setting for decision-making. Consistency is sometimes problematic. On any given day, a physician may be fatigued or under stress. She or he may be inexperienced in a particular medical specialty. Identical clinical data and parameter values monitored for one patient may be interpreted differently by two physicians, due to their different medical training, experience level, stress level or other factors. Transference/Interpretation problems exist. One physician's mental rules in the diagnosis of a medical condition may be hard to describe, and hence, difficult to transfer from one physician to another. These mental rules may also be difficult to explain to a patient if he asks how the physician arrived at the diagnosis, or even to document reasoning for use by other physicians. Non-linearity factors are often present. When the relationships between the monitored values and the patient's condition are complex and not well understood, conventional (e.g., linear, statistical) models are often inaccurate and thus not sufficient or reliable. Therefore, diagnostic technology using more complex nonlinear models is clearly preferable and often necessary.

These and other problems which are related, at least in part, to human error and limitations in the area of medical diagnosis can be addressed successfully using computer-aided diagnostic tools. Conventional computer-aided medical diagnosis is based on statistical data analysis. More advanced diagnostic tools are based on artificial intelligence (“AI”) technology which generally involves expert systems, fuzzy logic, artificial neural networks and various combinations thereof. The advent of effective commercially available software and hardware tools of these types has greatly broadened the base of potential and realized medical applications. Still, none of the presently available medical diagnostic tools is capable of adequately addressing the problems discussed above.

There are only a few existing expert system applications that employ some facet of fuzzy logic in complex systems, such as medical diagnosis. This is primarily because they have inherent limitations when applied to imprecise fields. Such current applications have inherent problems relating to the classification of patient states and medical decision-making. Existing medical applications using expert systems or fuzzy logic include MYCIN™, EMYCIN™, PUFF™, and OMERON™. MYCIN™ is used for diagnosing blood and meningitis infections. MYCIN™ took over 20 man-years to make and was 65 percent accurate compared to human physician accuracy of 42.5 to 62.5 percent. EMYCIN™ is an empty shell inference engine used in other areas. PUFF™ is used for diagnosing pulmonary problems. Omron is a Japanese company that developed a health management system, where over 500 fuzzy rules track and evaluate an employee's health and fitness. These existing applications are limited to small areas within medicine and are not realized commercially. In addition, intelligent, accurate medical applications are non-existent on the Internet.

Although expert systems can mimic human experts by implementing logic to reach a solution, human experts have many intangible, or fuzzy characteristics that cannot be duplicated by existing expert systems. Human experts, for example, learn by experience, restructure their knowledge, break the rules when necessary or appropriate, use intuition, determine the relevance of new facts and recognize the limits of their knowledge. As human experts start encountering unfamiliar situations, they become more cautious. The performance of human experts usually degrades as they move into unfamiliar territory. Nonetheless, in many instances, human experts can use intuition or common sense in perceiving situations where the existing knowledge does not apply, and can decide what rules to break in order to reach a reasonable solution.

By contrast, an expert system (even those employing fuzzy rules) has no inherent common sense, and operates totally within the bounds of the rules and knowledge stored in its knowledge base (database or user-provided). The only facts recognized by existing expert systems are the facts related to the “if” portions of the if-then rules in their knowledge base. Expert systems tend to either quit or make bad mistakes when they encounter situations not provided for by data included in their knowledge base. It is possible to add new facts and new rules to an expert system, but each upgrade is a program enhancement that must be debugged or revised system to ensure conformity with the system's logic.

Therefore, existing diagnostic tools based on classical statistical methods, expert systems and simple neural network methods have significant limitations. When applied to complex systems, such as medical diagnosis, the results obtained are not well understood and are often limited in accuracy.

Therefore, there is a need to develop a system of decision making that minimizes flaws inherent to human decision making such as poor framing, recency effects, primacy effects, poor probability estimation, overconfidence, escalation phenomena, association bias and “groupthink.” There is a need to develop a expert system for decision making, that emulates the human decision-making process, that is not based on the application of statistics, probability or certainty factors, and that does not require large statistical data bases. There is a need for a system and method of decision-making that ranks possibilities, among a set of alternative possibilities, according to likelihood based on values provided by a human expert taking into account the expert's intuition, cognition and experience. There is, in particular, a need for expert systems that are applicable to complex systems, such as medical diagnosis. There is a need for an expert system that determines the nature of a particular medical condition with greater accuracy, and provides a diagnosis in a way that identifies and catalogues all factors that were significant in the process of making the diagnosis.

### SUMMARY OF THE INVENTION

The present invention provides an process, apparatus and method for decision making, based on emulation of the human decision-making process in ranking a set of alternate possibilities according to their relative likelihood. The apparatus of the present invention comprises a computer or computer network apparatus to facilitate emulation of the human decision-making process, the decision comprising a ranked set of alternative possibilities. The computer network apparatus comprises a server, and one or more user subsystems connectable thereto.

The computer or server, as the case may be, comprises a processor with a storage device connected to the processor. The storage device has stored thereon one or more relatable data bases, comprising expert-generated primary bias data, queries and alternatives possibilities (e.g., diagnoses), and a program stored on the storage device for controlling the processor. The program is operative with the processor to receive a user's set of query responses, query the bias data and alternative possibility databases based on the user's responses and provide a decision, comprised of a ranked set of alternative possibilities, said ranking being according to relative likelihood among the alternative possibilities, and transmit (in the case of the server) the ranked set of alternative possibilities to the user at a user subsystem. The user subsystem is connected to the server, and comprises a computer operative with a program stored thereon to receive from a user input of a user's set of query responses, transmit to the server the user's set of query responses, and receive from the server the ranked set of alternative possibilities.

The present invention provides a process for emulating human decision making on a computer having a processor and a storage device connected to the processor, comprising: (a) configuring, in one or a plurality of electronic data bases stored in the storage device of the computer, a possibility set comprising a plurality of alternative possibilities, a query set comprising a query, and a set of primary bias values provided by an expert having knowledge of the alternatives, wherein each primary bias value is associated with a particular alternative, and reflects the expert's conception of the relative degree of predictive value of the query for the particular alternative relative to other alternatives in the possibility set; (b) inputting a user's response to the query into the computer; and (c) ranking, using a program stored on the storage device that is operative with the processor to receive and process the user's response, the set of alternative possibilities according to relative likelihood, based at least in part on the set of primary bias values, whereby a decision, comprising the set of ranked alternatives, is provided. Preferably, ranking the set of alternative possibilities comprises querying the electronic data bases to determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set. Preferably, determining the set of secondary bias values involves increasing, decreasing or conserving the corresponding primary bias values based on the response to the query. Preferably, the query set comprises a plurality of queries, and ranking the alternatives in the possibility set involves summing and averaging of the primary or secondary bias values. Preferably, determining a set of corresponding secondary bias values, and ranking the alternatives in the possibility set is achieved by using an ELICIT™ “Algorithm 42” core algorithm to process one or more of the primary or secondary bias values. Preferably, the possibility set is a set of alternate medical diagnoses, the expert is a medical expert, and ranking the alternatives in the possibility set, based on the primary bias values, provides a diagnosis comprising the set of alternate medical diagnoses, ranked according to likelihood.

The present invention further provides a computer apparatus for facilitating emulation of human decision making, comprising: (a) a computer comprising a processor and a storage device connected to the processor; (b) a possibility set database stored on the storage device, wherein the possibility set database comprises a plurality of alternative possibilities; (c) a query set database stored on the storage device, wherein the query set database comprises a query; (d) a primary bias value data set stored on the storage device, wherein the primary bias values are provided by an expert having knowledge of the alternative possibilities, and wherein each primary bias value is associated with a particular alternative, and reflects the expert's conception of the relative degree of predictive value of the query for the particular alternative relative to other alternatives in the possibility set; and (e) a program stored on the storage device for controlling the processor, wherein (i) the program is operative with the processor to receive a user's response to a query, (ii) determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set, (iii) rank the alternatives in the possibility set, based on the secondary bias values, to provide a decision comprising the set of alternative possibilities, ranked according to likelihood, and (iv) present the decision to the user. Preferably, the apparatus further comprises a user database stored on the storage device, wherein the program is operative with the processor to store user information in the user database, and update user information when new user information is received. Preferably, the program is further operative with the processor to track user information. Preferably, the possibility set is a set of alternate medical diagnoses, the expert is a medical expert, and ranking the alternatives in the possibility set, based on the primary bias values, provides a diagnosis comprising the set of alternate medical diagnoses, ranked according to likelihood.

Additionally, the present invention provides a process for emulating human decision making over a wide-area network, comprising: (a) configuring, in one or a plurality of electronic data bases of a server, a possibility set comprising a plurality of alternative possibilities, a query set comprising a query, and a set of primary bias values provided by an expert having knowledge of the alternatives, wherein each primary bias value is associated with a particular alternative, and reflects the expert's conception of the relative degree of predictive value of the query for the particular alternative relative to other alternatives in the possibility set; (b) inputting a user's response to the query into a computer through a user subsystem; (c) transmitting the user's response to the server over the wide-area network; (d) ranking, using a program that is operative with a processor of the server to receive and process the user's response, the set of alternative possibilities according to relative likelihood, based at least in part on the set of primary bias values; and (e) transmitting the ranked set of alternative possibilities to the user subsystem over the wide-area network, whereby a decision, comprising the set of ranked alternatives, is provided. Preferably, ranking the set of alternative possibilities comprises querying the electronic data bases of the server to determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set. Preferably, determining the set of secondary bias values involves increasing, decreasing or conserving the corresponding primary bias values based on the response to the query. Preferably, the query set comprises a plurality of queries, and ranking the alternatives in the possibility set involves summing and averaging of the primary or secondary bias values. Preferably, determining a set of corresponding secondary bias values, and ranking the alternatives in the possibility set is achieved by using an ELICIT™ “Algorithm 42” core algorithm to process one or more of the primary or secondary bias values. Preferably, the possibility set is a set of alternate medical diagnoses, the expert is a medical expert, and ranking the alternatives in the possibility set, based on the primary bias values, provides a diagnosis comprising the set of alternate medical diagnoses, ranked according to likelihood.

The present invention also provides a computer network apparatus for facilitating emulation of human decision making, comprising: (a) a server comprising a processor and a storage device connected to the processor; (b) a possibility set database stored on the storage device, wherein the possibility set database comprises a plurality of alternative possibilities; (c) a query set database stored on the storage device, wherein the query set database comprises a query; (d) a primary bias value data set stored on the storage device, wherein the primary bias values are provided by an expert having knowledge of the alternative possibilities, and wherein each primary bias value is associated with a particular alternative, and reflects the expert's conception of the relative degree of predictive value of the query for the particular alternative relative to other alternatives in the possibility set; and (e) a program stored on the storage device for controlling the processor, wherein (i) the program is operative with the processor to receive, from a user subsystem, a user's response to a query, (ii) determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set, (iii) rank the alternatives in the possibility set, based on the secondary bias values, to provide a decision comprising the set of alternative possibilities, ranked according to likelihood, and (iv) transmit the decision to the user subsystem. Preferably, the apparatus further comprises a user database stored on the storage device, wherein the program is operative with the processor to store user information in the user database, and update user information when new user information is received. Preferably, the program is further operative with the processor to track user information.

The method may comprise a computer or computer network to emulate the human decision-making process in ranking a set of alternate possibilities according to their relative likelihood. The present invention provides a method for emulating human decision making, comprising: (a) establishing a possibility set comprising a plurality of alternative possibilities, each having a distinguishing attribute; (b) establishing a query set comprising a query; (c) relating the query to each alternative in the possibility set using a set of primary bias values provided by an expert having knowledge of the alternatives, wherein each primary bias value is associated with a particular alternative, and reflects the expert's conception, based on the distinguishing attribute, of the relative degree of predictive value of the query for the particular alternative relative to other alternatives in the possibility set; (d) obtaining a response to the query; (e) determining, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set; and (f) ranking the alternatives in the possibility set, based on the secondary bias values, to provide a decision comprising the set of alternatives, ranked according to likelihood. Preferably, the set of secondary bias values involves increasing, decreasing or conserving the corresponding primary bias values based on the response to the query. Preferably, the query set comprises a plurality of queries, and ranking the alternatives in the possibility set involves summing and averaging of the primary or secondary bias values. Preferably, determining a set of corresponding secondary bias values, and ranking the alternatives in the possibility set is achieved by using an ELICIT™ “Algorithm 42” core algorithm to process one or more of the primary or secondary bias values. Preferably, the possibility set is a set of alternate medical diagnoses, the expert is a medical expert, and ranking the alternatives in the possibility set, based on the secondary bias values, provides a diagnosis comprising the set of alternate medical diagnoses, ranked according to likelihood. Preferably, the possibility set is a set of alternate medical diagnoses, the expert is a medical expert, and ranking the alternatives in the possibility set, based on the primary bias values, provides a diagnosis comprising the set of alternate medical diagnoses, ranked according to likelihood.

### BRIEF DESCRIPTION OF THE DRAWINGS

FIG. 1 shows an example of an art-recognized Knowledge-based System Environment (“KBS”), CLIPS™. Essential to a basic KBS are: the working-memory context (which stores the input from a user), a knowledge base which contains if-then rules (that represent acquired knowledge), and an inference engine (that evaluates the inputs according to the knowledge base to provide an output, with reference to how it arrived at the outcome).

FIG. 2 shows a schematic diagram of a “belief network.” A belief network, well known in the art, is expressed as an acyclic, directed graph where the variables, X₁, X₂, and X₃ correspond to “nodes” and the relationships between the nodes correspond to “arcs.” Associated with each variable in a belief network are probability distributions.

FIGS. 3 and 4 show the 3-D ELICIT™ model, which is a visual representation of a 3-D ELICIT™ data set. Queries, responses and diagnoses are all inter-related in a 3-D ELICIT™ set. The 3-D ELICIT™ model interrelates data used in representing expert data.

FIG. 5 shows the “End Implementation” of a preferred embodiment of the present invention. When the possible diagnoses are ranked, according to relative likelihood, by the inventive process, the user can optionally read more information on those diagnoses, leading the user to additional windows where they can learn about cures, treatments, drugs, home remedies, exercises, therapies, and other related information. The user can also optionally access related health services, health insurance, physicians directory, appointments with specialists, and other related services. Other optional features include, e.g., printing a coupon for a non-prescription drug for a local pharmacy, directions to that pharmacy and interaction with an insurance plan's physician directly over a secure connection, allowing the physician to prescribe to the user online.

FIG. 6 shows a flow diagram of the process of acquiring expert data: the primary Bias Data (B), Possible Alternatives (D) and the Queries (Q) needed to emulate expert decision-making. The first step involves listing all possible alternatives (diagnoses) for a particular model. Second, all relevant and intuitive queries are determined, and finally the primary bias data set is established by the expert. This process can be implemented on any system or using any interface such as the Internet. After all the particular data sets have been established, the expert tests the integrity of expert system and updates any primary bias data, alternative or query accordingly. Afterwards, a field test is conducted in the experts field or environment.

FIG. 7 shows a spreadsheet comprising, according to the present invention, three ELICIT™ sets, including an expert-determined fuzzy primary bias data set is shown, comprising relative bias values from 10 to 90.

FIG. 8 shows how personal attributes and user response rankings are set according to the present invention using an editing window. This figure illustrates aspects of applicant's novel approach in emulating a true “virtual doctor” experience. For example, the user may optionally establish personal attributes to the responses the system accepts. A user may want to respond to a query with a “maybe.” However, one user's definition of “maybe” may be different from another's. Similarly, fine tuning the user response rankings is another innovative option, makes the online physician emulator more accurate. This figure shows the process by which a user introduces “fuzziness” into the inventive system by selecting a graded response ranking between 0.1 and 9.9, and thereby increasing the accuracy of the inventive system. Accuracy is increased because the inventive program uses the User Responses Rankings as “modifiers” (and simple as activators) of the primary bias values.

FIG. 9 shows a basic computer model with a central processing unit (“CPU”), Hard Storage (“Hard Disk”), Soft Storage (“RAM”), and an Input and Output interface (“Input/Output”). A consumer, at a user interface, is either interested in specific health information, access to health services, or is concerned about a recent injury or malady. Once they log on to a host site, a main window screen is displayed giving the options to login as a registered user, use the “smart” search, or directly access the Online Physician Emulator (“OPE™”) interface.

FIG. 10 shows the general description of the Online Physician Emulator (“OPE™”), which is a preferred embodiment of the present invention. The figure shows apparatus and implementation of the method of decision-making in a medical context via the Internet (i.e., the OPE™). The user will first access the “Main Screen.” At the Main Screen, the user has the option to Login as a “member,” do a general search, or directly access the OPE™ or “virtual doctor.” This Figure describes the process and sequence of: entering the inventive OPE™ system; logging onto the system; setting response ranking options; inputting basic health information; entering a primary complaint; selecting an area or condition of health problem; answering queries posed by the system; receiving a decision comprising a ranking of alternative diagnostic possibilities in a possibility set, assessing and reading the related health information of causes and treatments.

FIG. 11 shows a LOGIN/ENTER BASIC HEALTH STATS screen, according to the present invention. The figure shows, in flow diagram form, the process of a user logging onto the OPE™ system and setting various personal options, such as the personality of the “virtual doctor,” viewing personal health history, viewing previous uses of the system, entering basic personal health information and setting the response-ranking options. The Login window allows, among other options, the consumer to update their basic personal and health data (age, sex, height, weight, etc.), choose a doctor personality profile, or become a full member of the service. As a full member, the consumer is entitled to a newsletter, access to their medical health record, and other specialized services. The login information is stored in a database.

FIG. 12 shows the “smart” search process. The “smart” search window allows the user to enter a full-text search request and select specific parameters. When the user submits the search request, a “parser” evaluates that request and may return a query to help focus the search. Afterwards, an algorithmic search is performed using ELICIT™ to rank the search results in order of highest relevance according to the search parameters entered.

FIG. 13 shows how user responses to query sets are processed according to the present invention. After all the responses (R₂) have been submitted by the user, the system's inventive algorithm evaluates the responses for the specific diagnostic conditions and location. When the calculations are finished, a list of the top (according to relative likelihood) 3 or 4 diagnostic possibilities are displayed in a new window. All the responses and evaluations are stored as a history for the user to reference upon return to the web site, and by the experts to validate the data set. This figure represents the basic flow of processing responses and evaluating possible outcomes.

FIG. 14 shows an example of a picture used to help determine a diagnosis according to the present invention.

FIG. 15 shows a representative screen shot of the Online Physician Emulator (“OPE”). The depicted screen, according to the present invention, serves to orient the user upon accessing on to the system.

FIG. 16 shows a sample user interview, prompting the user for responses the queries, as shown on a web page.

FIG. 17 This figure shows how primary bias values, user response values, and dependencies are selected and represented, according to the present invention. Upper panel: For primary Bias Data (B) (provided by an expert), the range of possible relevance/likelihood is shown as being from 0 to 100, but is not limited to this range or numeric representation. The range can represent 0 to 1. However, there is a median or null value of zero (“0”) that symbolizes the default response (R) of “no.” Middle panel: User response values, or modifiers, are values that modify the primary Bias Data (B), based on the type of qualitative response inputted by the user. The user response values are also subject to a fuzzy range consisting of 0 to 1, but not limited to this particular range or numeric representation. Again, zero (“0”) is represents the qualitative response of “no,” whereas “yes” corresponds to a value of one (“1”). Lower panel: For alternative diagnoses in the possibility set that are particularly “dependent” (i.e., that are particularly significant or relevant) for a particular query, there is the Absolute Dependency Modifier (“ADM”) that also modifies the primary Bias Data (B) based on the absolute responses (R) of either “yes” or “no.”

FIG. 18 shows the main expert editing screen, used for editing what expert data, according to the present invention.

FIG. 19 shows, for a “Pre-diagnostic Questionnaire” according to the present invention, a sample list of possible queries for a knee injury subject area that are modifiable. Representative user responses to the query set are shown in the left column boxes.

FIG. 20 shows a sample evaluation of queries, relating to knee injury diagnoses knee diagnoses possibility, processed according to the present invention. This example shows that the most likely four diagnoses, based on the user's responses to the two queries, were: ankle sprain III; ankle sprain I and II; achilles rupture; and osteochondritis dissecans.

FIGS. 21-24 show contiguous portions of an edit data screen according to the present invention. Such edits screens provide an interface where the expert can change the format of the query (left column), the primary bias data associated with the query (middle column values), and determine other variables, such as whether a diagnostic dependency exists for a particular query/diagnosis relational pair (i.e., by checking one or more boxes in the right column).

FIG. 25 shows how an expert can modify, according to the present invention, the primary bias data for one or more particular queries, and reevaluate the possibility rankings for the set of alternate diagnoses, immediately after said modifications.

FIG. 26 shows an example of a “Pre-diagnostic Questionnaire,” according to the present invention, that is used to evaluate and test actual data in the field, such as in clinics and hospitals to generate a diagnoses.

FIG. 27 shows the format of a Query Object in Database (“QOD”), according to the present invention. This figure illustrate a method for storing the primary Bias Data (B), Queries (Q) and the alternatives or diagnoses (D) in a relational database. The flexibility of incorporating new data and concepts, and associating information and allowing update is represented in the QOD approach. The query represents a single and primary test between alternatives and plays a key factor in linking information necessary in decision-making. Here, all forms of information relating to a query, variations on the query itself, primary Bias Data (B), diagnostic dependencies(“ADM”), personality profiled queries, expert-inputted default responses to a particular query, voice, video, keywords and other types of related information are stored in the QOD.

FIGS. 28 and 29 show the format of the static ELICIT™ data sets for CGI scripts.

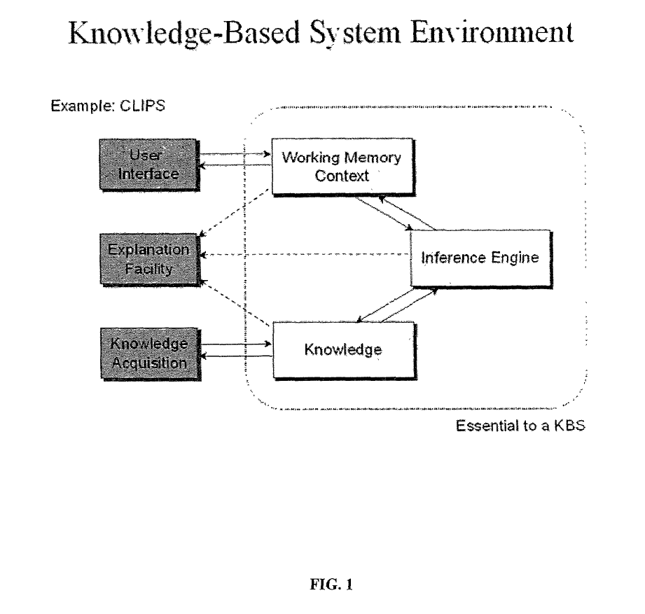

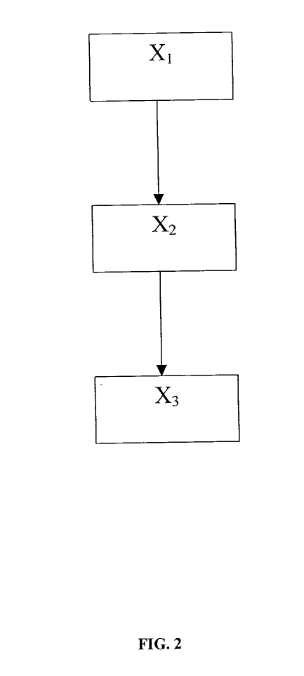

### DETAILED DESCRIPTION OF THE INVENTION

OVERVIEW

The present invention provides a process, apparatus and method for decision-making, based on emulating the human decision making process. The invention is based on applicant's theory that human cognition and intuition can be modeled by capturing an expert's conception of relevance between data sets in the form of a expert-provided bias value. The inventive process, apparatus and method of emulating human decision making is the application of that theory, which the applicant refers to herein as ELICIT™ (Emulating Logical Inferences of Cognition and Intuition Theory). ELICIT™ enables the formalization of uncertain/qualitative knowledge, decision-making and inferences from imprecise data. Thus, the system emulates human intuitive thinking and logic patterns.

Previous information systems and expert systems have attempted to diagnose a system that elicits symptoms in a nature related to the system. For example in medicine, a patient exhibits symptoms and a doctor or an expert system will attempt to arrive at a diagnosis. Unlike, the present invention employing ELICIT™, these expert systems are inadequate, limited and fail to emulate the human decision-making process.

In one embodiment, the present invention provides a method for emulating a physician's medical diagnosis. The invention accomplishes this by emulating the doctor/physician decision-making process in achieving a diagnosis based on user responses to expert-based (physician-based) queries. The queries can be symptom based but are not limited to that domain. ELICIT™ is used in this emulation process along with fuzzy logic and other expert systems concepts. The preferred implementation is on the Internet as a medical/health self-assessment application (OPE™/ODE™); online physician emulator; online doctor emulator) linking the user to treatments, drugs, health insurance and other health or medical related services and information. These and other objects are achieved in accordance with the present invention by providing a novel medical diagnosis system including an expert system.

The invention, in some embodiments, is a software system and method that provides for decision making by ranking alternative possibilities according to likelihood. In the preferred embodiments, the system emulates/simulates a doctor and diagnoses maladies. The maladies may be medical or psychological. In alternative embodiments, the system can diagnose machinery problems, software problems or any problem that manifests symptoms. In the preferred embodiments, the system evaluates user responses to queries and displays diagnoses. The system can be hosted on the World Wide Web (“Web”), a computer system within an office, at a remote location, or in an electronic device, such as the various hand-held communication and processing devices familiar in the art.

Basically, the system prompts the user through a series of screens. In the preferred embodiment, the first screen includes a picture of a body (human or animal). The user clicks on the part of the body that is exhibiting the problematic symptoms or that represents the user's primary complaint. In anther embodiment, the user may also input the symptoms or primary complaint directly into the system. In yet another embodiment, the user may select to enter the system by choosing a corresponding specialty or area that reflects the users symptoms or primary complaint. One or more screens are then presented asking the user queries relating to the symptoms or primary complaint. The user enters responses that are evaluated by the system. Each query corresponds to a set of possible alternative diagnoses, the possibility set. Each diagnosis has a possibility factor for a given query called a primary bias value, that is provided by a human expert (e.g., a medical expert such as a physician). The bias value reflects the expert's conception of the relative degree of predictive value of the query for the particular alternative diagnosis relative to other alternatives in the possibility set. The system evaluates the user responses to provide a set of secondary bias values, and ranks the alternatives in the possibility set, based on secondary bias values, to provide a decision comprising the ranked set of alternatives.

Expert knowledge regarding diagnosis is encapsulated in both the primary and secondary bias values. The primary bias values are preset by a human expert according to the expert's conception (e.g., knowledge, intuition, judgment and experience) of the relative degree of predictive value of the query (more accurately, the value of the response to the query) for the particular alternative diagnosis relative to other alternatives in the possibility set. These expert-provided bias values are activated, or modified according to the user responses to provide secondary bias values. Typically the user responds by clicking a “yes” or “no” for each query, or a gradation of yes or no, such as “sometimes.” The user can, however, enter any response to a particular query that can be reflected in a range and degree, provided that the option to fine tune the response by selecting such a range or degree is available for the particular query. The graded value (i.e., “sometimes”) representing the user response for a given query reflects the user's conception (e.g., comprehension, memory of symptom, degree of symptom, etc.) of the degree to which the response to the query is true or relevant.

The corresponding primary bias value for each diagnosis is multiplied by the user response value to enable calculation of the corresponding secondary bias value. For example, if a user responds to a query with a “sometimes,” having a user response value of 0.5, and the primary bias value for an ACL tear diagnosis for that query is, e.g., 0.6, then the user response 0.5 is (in the absence of a “diagnostic dependency”; see herein below) simply multiplied by the primary bias value 0.6 to produce a secondary bias value of 0.3. After the products for all queries and corresponding diagnoses are calculated, the products for each possible diagnosis are summed and averaged by the number of queries answered or activated by any change in state or any positive degree of response other than the default response of the query which is null state (e.g., a response of “no”, but is not limited to that domain and the default state can be qualified or quantified in an unlimited way). The average values, representing the ranking values of the alternatives, indicate the most likely diagnoses. Typically, the four most likely diagnoses are displayed. However, a complete ranking of all diagnoses is optionally available to the user. Typically, an average accuracy of the system of about 98% is embodied in the four most-likely diagnoses.

In one embodiment, the queries, and diagnoses are grouped according to medical specialty (i.e., orthopedics, heart, internal medicine, etc.). In another embodiment, a user interface allows the system to provide either more or less elaboration (related information) on each diagnosis, depending on the type of end user. In yet another embodiment, the user interface is a “virtual doctor” that emulates/simulates different doctor personalities, which the user can select. The manner in which the queries and the explanations are given to the user is based on the doctor personality.

Additionally, the system may optionally provide (i.e., recommend) possible actions for a user/responder to take for a given diagnosis. These possible actions include, but are not limited to reported causes of the problem, treatments, specialists, home remedies, prescriptions and nonprescription drugs, health insurance, health product manufacturers for each diagnosis, hospitals, pharmacists and support groups, etc.

SYSTEM AND METHOD FOR EMULATING HUMAN DECISION MAKING.

The present invention provides a method of decision making or diagnosis by processing responses to queries, or symptoms. The invention is applicable to any subject or problem area that manifests “symptoms” or any domain that requires decision-making. Symptoms include test results, or responses to queries. For example, in the medical context, test results include cholesterol counts to determine general health or heart condition. The invention is applicable to diagnosing both inanimate and animate (e.g., biological or non-biological) symptoms. Thus, the invention is applicable to diagnosing machine symptoms, software problems, or any problem manifesting symptoms. The present invention encompasses software applications using an algorithm and a variation of fuzzy logic to make queries and diagnoses in the attempt to emulate the physician decision-making process.

The subject technology relates to expert system theories ranging from fuzzy logic to knowledge-based systems. The invention also relates to the medical field, its specialties and to related businesses such as insurance, medical care products and medical/health services. In the preferred embodiments, the system emulates/simulates a “virtual doctor” that diagnoses human or animal maladies. The maladies may be medical or psychological. The system evaluates user responses to queries and displays diagnoses on the screen. In alternative embodiments, the user can enter user responses in a pre-formatted form, such as a questionnaire. In a preferred embodiment of the invention, the system uses ELICIT™, and “fuzzy” logic concepts to produce a medical diagnosis (i.e., the system is an expert system using ELICIT™ as its model).

Applications of the present invention include, but are not limited to, teaching tools and advanced managed care tools for hospitals and HMOs, where the program determines what tests are still needed to sufficiently determine a diagnosis for a health care client/patient. This process saves money by eliminating wasted and unnecessary testing, such as DSS (i.e., Decision Support System—an expert system designed to aide an expert in their field). Other embodiments include any diagnostic-based expert system that must process imprecise responses to queries. In other embodiments, the system accepts responses to queries in the form of precise or tangible data (e.g., test results), where ELICIT™ helps to narrow and determine the diagnosis and offer targeted information.

The inventive system is the application of the applicant's ELICIT™ concept to diagnosing any problem domain exhibiting symptoms or requiring decision making. The system emulates/simulates human intuitive thinking, logic patterns, and decision making through approximation, weighted average algorithms, and more. ELICIT™ is a Human Logic Approach. ELICIT™ is a variation of fuzzy logic, knowledge-based systems, and belief networks.

Current applications of fuzzy logic and expert systems require a complex inter-related set of parameters, because current logic applications are not inherently inter-related. Thus, current expert systems and even fuzzy logic sets and rules are limited, because the inference and/or rules are applied/processed independently of each other. Though the calculations occur, and must occur simultaneously for all data sets, the data set references only one inference and/or rule at a time.

By contrast, the human brain and human thinking is not only “fuzzy” but also employs simultaneous and inter-related comparative inferences. Likewise, instead of using single inference fuzzy sets and rules, the ELICIT™ system allows for multiple reference to the same set and even subset. The system allows for dynamic, compact and intuitive data implementation. Two-dimensional (“2-D”) sets, three-dimensional (“3-D”) sets, and more are possible with the system's sets, and surpass the limitations of single dimensional “fuzzy sets.” Thus, the ELICIT™ logic simulates both “fuzziness” and inter/intra related inferences. The ELICIT™ approach borrows from many related expert systems theories, primarily, “fuzzy logic” and “knowledge-based.”

One advantage of ELICIT™ over existing expert systems (e.g., if-then systems) is the use of relatively small data sets as compared to traditional decision tree programming. The human brain not only applies “fuzzy” rules and “fuzzy” thinking to routine problem solving and decision making, but also does it implicitly and with tremendous speed. Both speed and logical inference is derived from using inter-related references in processing inputs/stimuli and outputs. Using inter-related references (i.e., inter-related data sets) is less data intensive than traditional tree programming.

A preferred embodiment of the present invention is a holistic, comprehensive, self-assessment application using a multi-fuzzy approach, inter-related ELICIT™ sets, and software-imbedded heuristics. Heuristics involves or serves as an aide to learning, discovery or problem-solving by experimental and, especially, trail-and-error methods. Also, heuristics relate to exploratory problem-solving techniques that utilize self-educating techniques (as the evaluation of feedback) to improve performance.

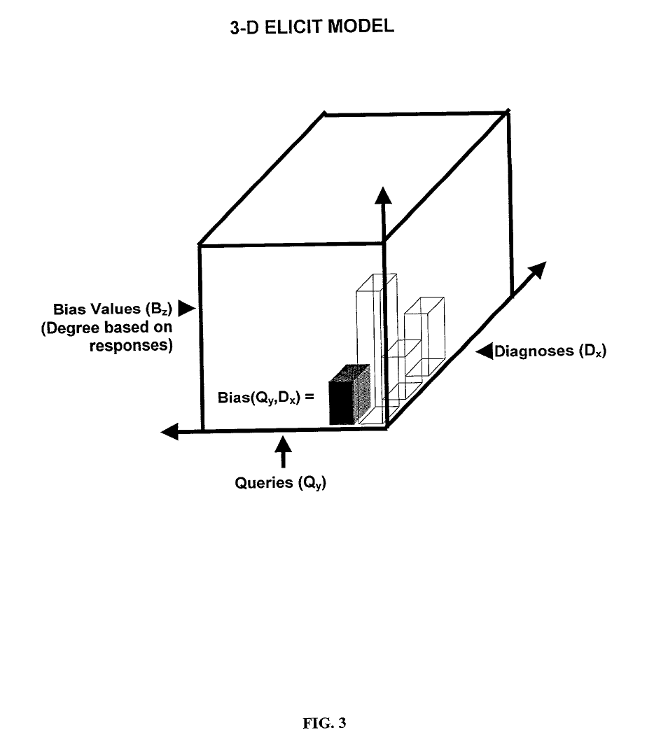

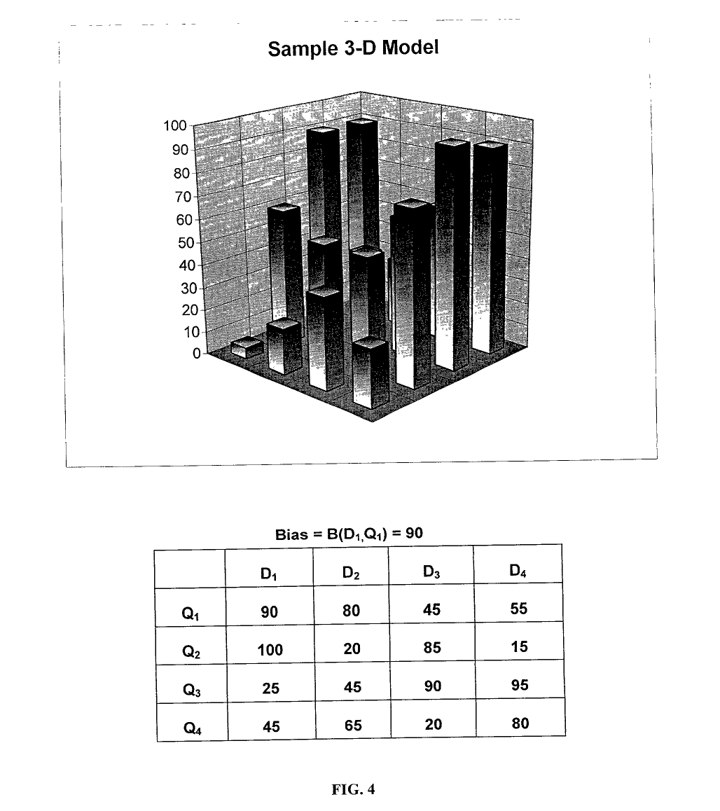

In one embodiment of the invention, the system uses 3-D ELICIT™ sets that are all inter-related. FIGS. 3 and 4 show the 3-D ELICIT™ model, which is a visual representation of a 3-D ELICIT™ data set. Queries, responses and diagnoses are all inter-related in a 3-D ELICIT ™ set. The 3-D ELICIT™ model interrelates data used in representing expert data.

The preferred ELICIT™ Model is 3-D based. Its advantage over other expert system representations is the inherent ability to compact data in a 3-D format versus a 2-D non-interrelated representation. The queries (Q), diagnoses (D) and bias values (R) are interrelated and represented using the ELICIT™ model. The ELICIT™ model is represented using a cube. Each 3-D bias data cell is interrelated to all others, belonging to both 2-D sets.

In either the either 2-D or 3-D ELICIT™ embodiments, queries from various medical areas may be displayed to the user. For example, queries pertaining to orthopedics, and queries pertaining to cardiology may be displayed to the user in succession.

The inventive system and method can be hosted on the Web, on a computer system within an office or at a remote location, or on an electronic device. In one embodiment, the system is built using the Filemaker Pro™ database program for the PC. In another embodiment, the system is in Perl Script™ running CGI™ on a private Web server operating Unix OS™. The invention is not limited to these embodiments and may be implemented using any computer language or computer system.

In the preferred embodiment, the system implements ELICIT™ to emulate a physician's decision-making process. The system is a medical/health self-assessment software application for consumers to use on the Internet. Consumers include users, students, professionals, and anyone with health concerns. In addition, the system is hosted on the Web, which allows users to access the system via any Web network, such as the Internet. The system provides health information and service on the Internet. The system is preferably located at a health Web site where consumers can diagnose there own conditions, get specific health or medical information and access a variety of heath related services. The system displays a possible set of diagnoses and then intuitively links them to specific and usable medical information. This “smart” information includes treatments, home remedies, prescription and nonprescription drugs, health insurance, health-product manufacturers, hospitals, local pharmacies, support groups, etc. The system is a health self-diagnostic tool for consumers to use on the Internet where they can interact almost immediately with a “virtual doctor” and get a self-diagnostic possibility as to their condition or health inquiry.

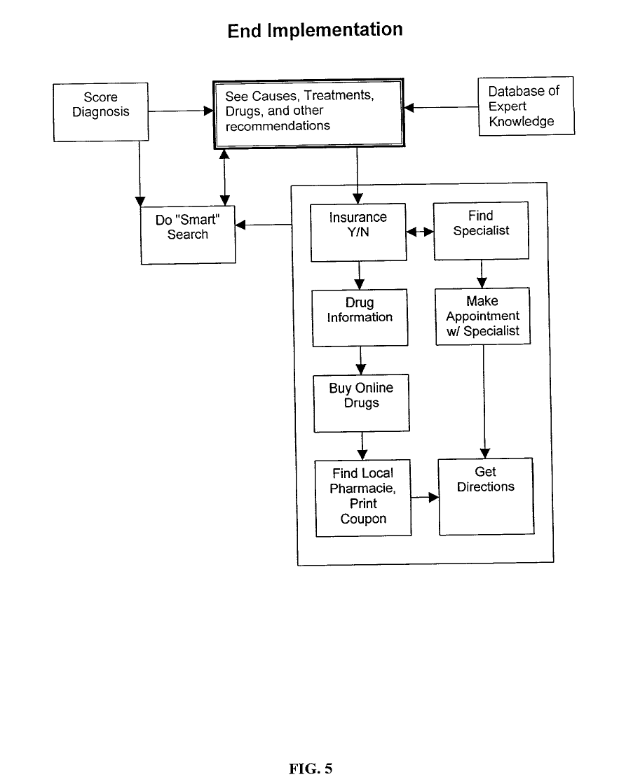

FIG. 5 shows the End Implementation of an embodiment of the present invention. For example, if a consumer (Internet surfer) has an injury, chronic condition or some malady, they can logon to a host site, respond to a few queries to establish a possible set of diagnoses (a possibility set), and link them to the following information that is “smart-searched” including, but not limited to, specific diagnosis, current cures and treatments, home remedies available, information on specialists in the area, health insurance, setting an appointment with a specialist/physician based on health insurance, online coupons for non-prescription drugs from local pharmacies, information on local pharmacies, information on local physical therapists, physician directories, support groups, health records, other medical information and links to other information.

The inventive system applies expert system concepts like “fuzzy logic” to the physician decision-making process. The system is an Online Physician Emulator (OPE™) using a variation of fuzzy logic called ELICIT™ on a self-assessment software program. In a preferred embodiment, the self-diagnostic application software is interactive, and on the Web, posing queries in a way similar to a physician taking a health history or doing an initial interview of a patient to narrow the diagnostic possibilities and the tests needed to verify the diagnosis. The algorithm used in programming this application is unique, and uses novel concepts in expert systems and their applications.

The system provides interactive diagnostic possibilities based on the consumer's own online responses to the systems queries. The system provides any number of possible diagnoses. For example, if there are three top diagnoses that are relatively close in being the most likely diagnoses, then all three diagnoses are be displayed. The system links the consumer to information about any diagnoses. The system can show a surgery clip (i.e., relevant video clip) or a physical therapy clip based on the malady diagnosed. The system narrows and intelligently guides the user to specific information concerning treatments, cures, prescription or over the counter drugs, therapies, and any other information that may help the user. Consumers thus avoid sifting through mountains of medical information, web pages and journal articles. Nor are they forced to wait in “virtual” lines to ask a “cyber” doctor about conditions that, due to patient-doctor legal issues, are limited in information content. The system is interactive and allows consumers seeking intelligent information to do a health self-assessment via the Internet.

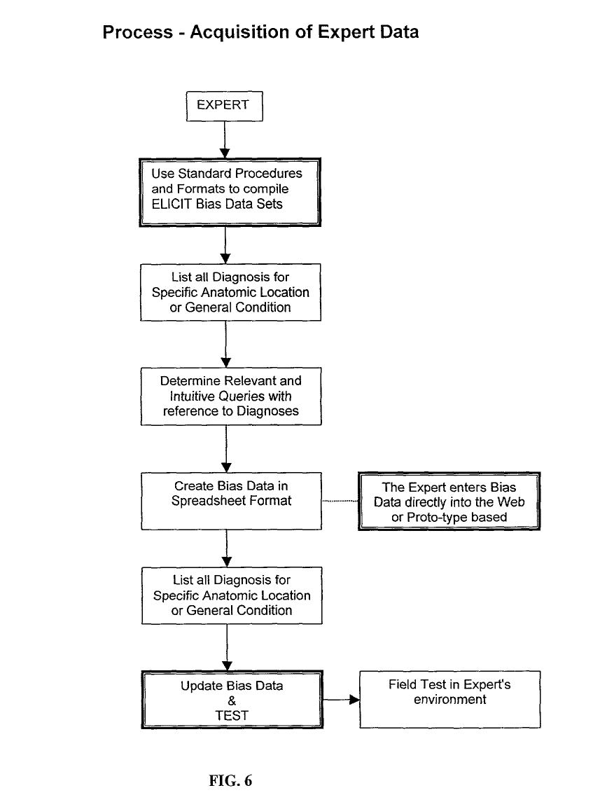

FIG. 6 shows a flow diagram of the process of gathering expert data (primary bias values). The system provides for standardization of expert data gathering and processing by encapsulating the expert data in weighing data (primary bias values). The modularization of the data allows the system to adapt and evolve smoothly and rapidly without much re-design.

The system uses a fuzzy algorithm that is both generational and relational in its programming. The system's ELICIT™ “Algorithm 42” (see herein, below) is generational to the extent that it creates fuzzy output of the diagnostic possibilities. The system's fuzzy algorithm is relational because it tracks the current state of the responses, the actions taken in responses and the output of the diagnosis. The software program utilizes a variation of a fuzzy weighted average of two ELICIT™ sets and an additional third set in a 3-D array algorithm that is an inter-generational algorithm or ELICIT™ Weighted Average.

The first ELICIT™ set comprises alternate diagnoses (i.e., possibilities) for a specific anatomical location or condition in a specific area of medicine (i.e., dermatology, orthopedics, etc.). The second ELICIT™ set comprises queries (i.e., test for the set of possibilities) relevant to the first ELICIT™ set. The third ELICIT™ set comprises unique possibility factors, referred to as bias values or bias (B), which are initially determined by experts (e.g., medical doctors, or specialists), and reflect the expert's conception of the relative degree of predictive value (i.e., the expert-conceived likelihood or relevance, and not the total probability) of a query for each particular alternative diagnosis relative to other alternatives in the possibility set. These primary bias values are activated by, and in some instances weighted, according to user responses to queries.

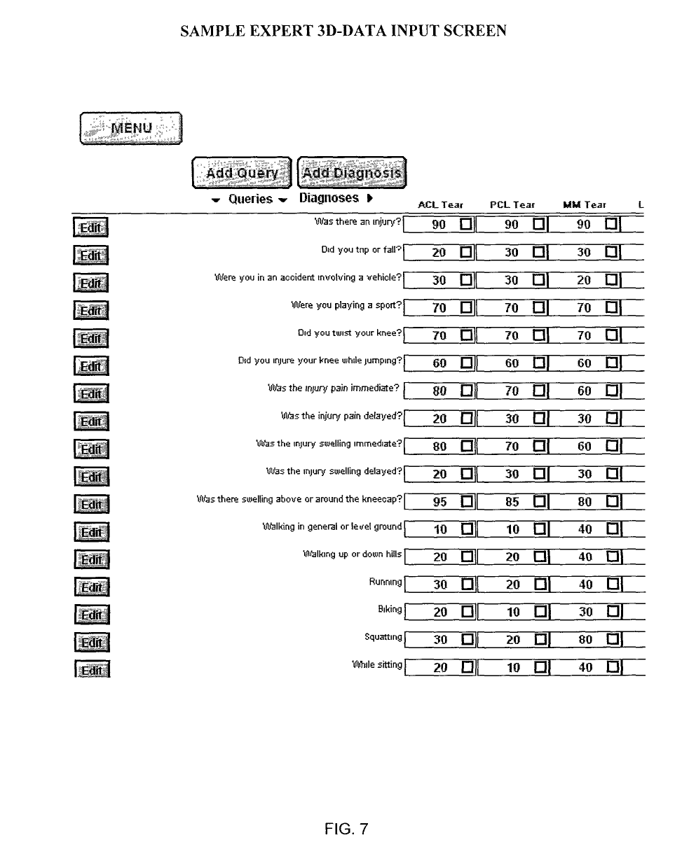

FIG. 7 shows a spreadsheet comprising the above-described three ELICIT™ sets, including an expert-determined fuzzy primary bias data set is shown, comprising relative bias values from 10 to 90 (in the example shown).

The system allows the user to alter the default response parameters to generate a graded response, and thereby make the ELICIT™ Algorithm more accurate.

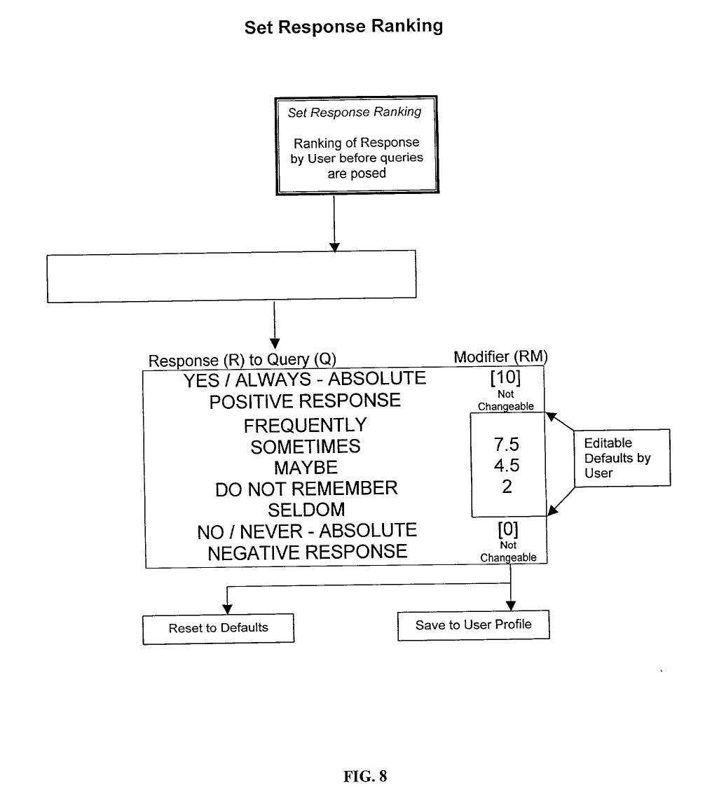

FIG. 8 shows how personal attributes and user response rankings (i.e., graded user response values) are set according to the present invention using an editing window. This figure illustrates aspects of applicant's novel approach in emulating a true “virtual doctor” experience. For example, the user may optionally establish personal attributes to the responses the system accepts. A user may want to respond to a query with a “maybe.” However, one user's definition of “maybe” may be different from another's. Similarly, fine tuning the user response rankings is another innovative option, makes the online physician emulator more accurate. This figure shows the process by which a user introduces “fuzziness” into the inventive system by selecting a graded response ranking between 0.1 and 9.9, and thereby increasing the accuracy of the inventive system. Accuracy is increased because the inventive program uses the User Responses Rankings as “modifiers” (and simple as activators) of the primary bias values.

Computer and on-line applications of the present invention; Online Physician Emulator (“OPE™”)

Consumers do not have an intelligent, fast and reliable method for accessing medical health information services. The present invention addresses this need by creating a software program able to creatively emulate the physician decision-making process online and link the consumer/user to specific health information and services. A consumer can access the Internet using a computer or electronic hand-held device. The software program of the present invention is usable in a stand-alone computer system.

The apparatus of the present invention is a computer, or computer network comprising a server, at least one user subsystem connected to the server via a network connecting means (e.g., user modem). Although referred to as a modem, the user modem can be any other communication means that enables network communication, for example, ethernet links. The modem can be connected to the server by a variety of connecting means, including public telephone land lines, dedicated data lines, cellular links, microwave links, or satellite communication.

The server is essentially a high-capacity, high-speed computer that includes a processing unit connected to one or more relatable data bases, comprising expert-generated primary bias data, queries (query data) and alternatives possibilities (possibility data, e.g., diagnoses). Additional databases are optionally added to the server. For example, in the case of medical self-diagnosis, desirable databases may include those containing: causes for the diagnosis; treatments for the diagnosis; new developments in the field of the diagnosis; support groups related to the diagnosis; etc. Also connected to the processing unit is sufficient memory and appropriate communication hardware. The communication hardware may be modems, ethernet connections, or any other suitable communication hardware. Although the server can be a single computer having a single processing unit, it is also possible that the server could be spread over several networked computers, each having its processor and having one or more databases resident thereon.

In addition to the elements described above, the server further comprises an operating system and communication software allowing the server to communicate with other computers. Various operating systems and communication software may be employed. For example, the operating system may be Microsoft Windows NT™, and the communication software Microsoft IIS™ (Internet Information Server) server with associated programs.

The databases on the server contain the information necessary to make the apparatus and process work. The expert-generated primary bias data base, queries (query data) data base, and alternatives possibilities (possibility data, e.g., diagnoses) database are relatable such that the primary bias data base contains expert-derived values that are uniquely associated with particular alternative possibilities (in the possibility data base), and reflect the expert's conception of the relative degree of predictive value of a particular query (in the query data base) for a particular alternative possibility relative to other alternatives in the possibility set. The databases are assembled and accessed using any commercially available database software, such as Microsoft Access™, Oracle™, Microsoft SQL™ Version 6.5, etc.

A user subsystems generally includes a processor attached to storage unit, a communication controller, and a display controller. The display controller runs a display unit through which the user interacts with the subsystem. In essence, the user subsystem is a computer able to run software providing a means for communicating with the server. This software, for example, is an Internet web browser such as Microsoft Internet Explorer, Netscape Navigator, or other suitable Internet web browsers. The user subsystem can be a computer or hand-held electron device, such as a telephone or other device allowing for Internet access.

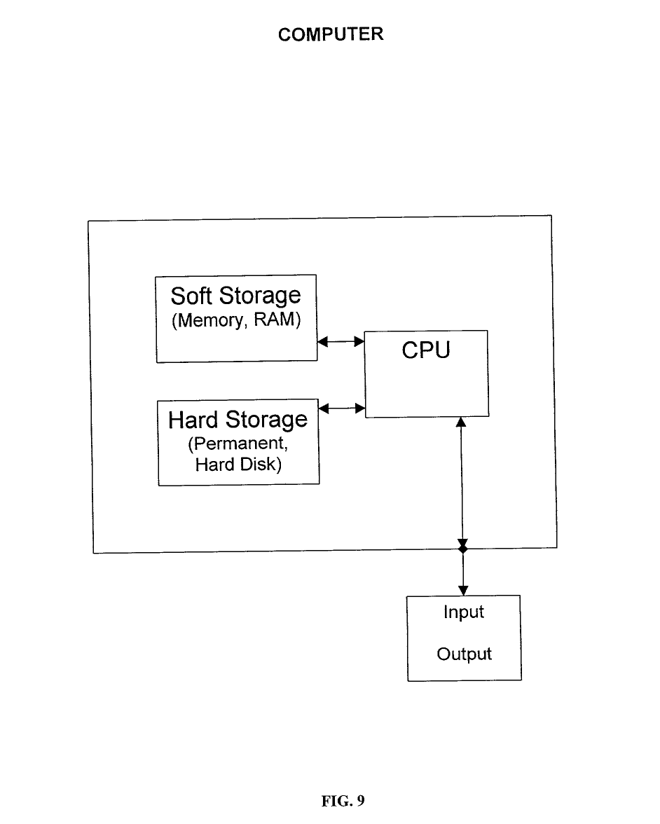

FIG. 9 shows a basic computer model with a central processing unit (“CPU”), Hard Storage (“Hard Disk”), Soft Storage (“RAM”), and an Input and Output interface (“Input/Output”). A consumer/user, at a user interface, is either interested in specific health information, access to health services, or is concerned about a recent injury or malady. Once they log on to a host site, a main window screen is displayed giving the options to login as a registered user, use the “smart” search, or directly access the Online Physician Emulator (“OPE™”) interface.

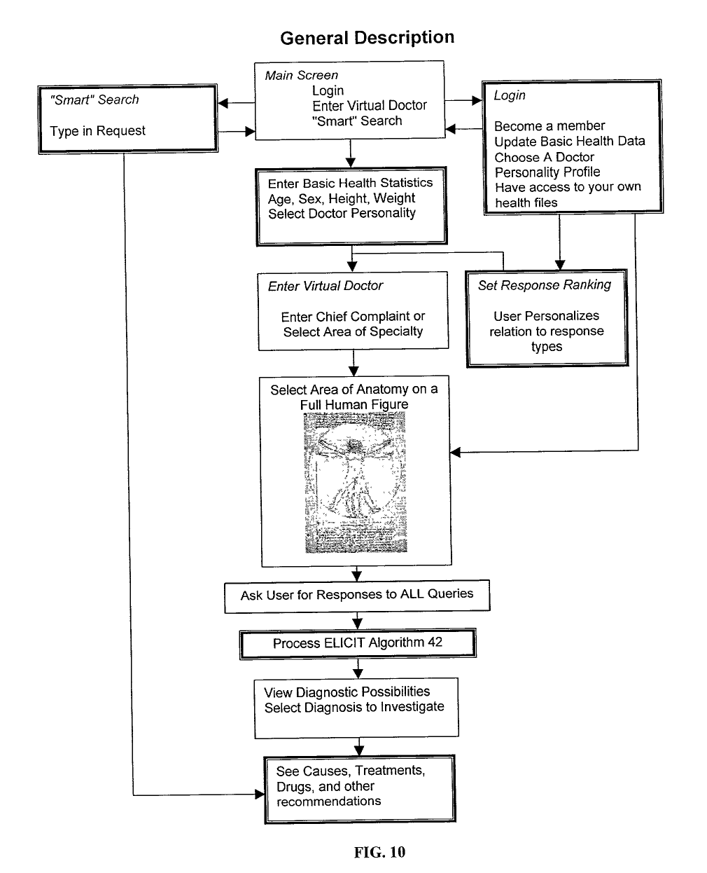

FIG. 10 shows the general description of the Online Physician Emulator (“OPE™”), which is a preferred embodiment of the present invention. The figure shows apparatus and implementation of the method of decision-making in a medical context via the Internet (i.e., the OPE™). The user will first access the “Main Screen.” At the Main Screen, the user has the option to Login as a “member,” do a general search, or directly access the OPE™ or “virtual doctor.” This Figure describes the process and sequence of: entering the inventive OPE™ system; logging onto the system; setting response ranking options; inputting basic health information; entering a primary complaint; selecting an area or condition of health problem; answering queries posed by the system; receiving a decision comprising a ranking of alternative diagnostic possibilities in a possibility set, assessing and reading the related health information of causes and treatments, and other related health information.

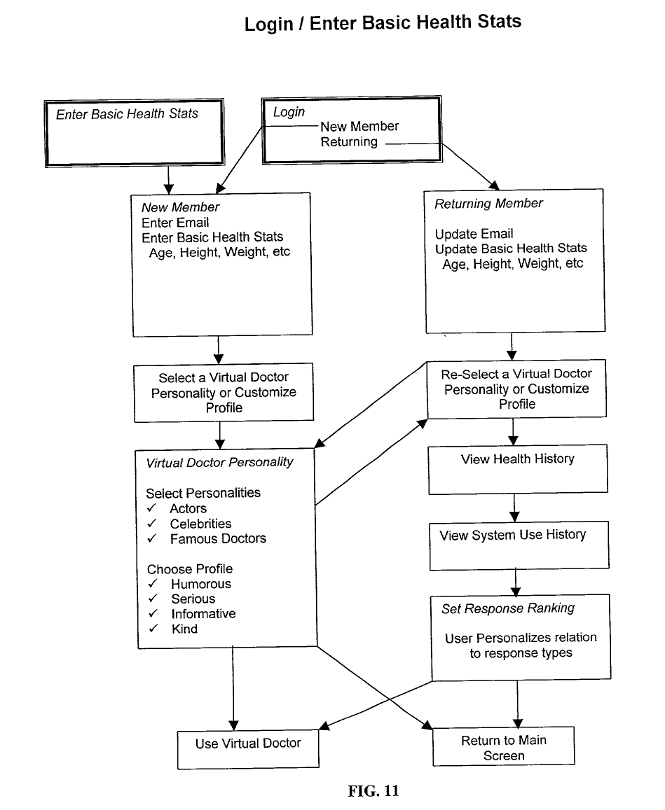

FIG. 11 shows the Login/Enter process, and a LOGIN/ENTER BASIC HEALTH STATS screen, according to the present invention. The figure shows, in flow diagram form, the process of a user logging onto the OPE™ system and setting various personal options, such as the personality of the “virtual doctor,” viewing personal health history, viewing previous uses of the system, entering basic personal health information and setting the response-ranking options. The Login window allows, among other options, the consumer to update their basic personal and health data (age, sex, height, weight, etc.), choose a doctor personality profile, or become a full member of the service. As a fall member, the consumer is entitled to a newsletter, access to their medical health record, and other specialized services. The login information is stored in a database.

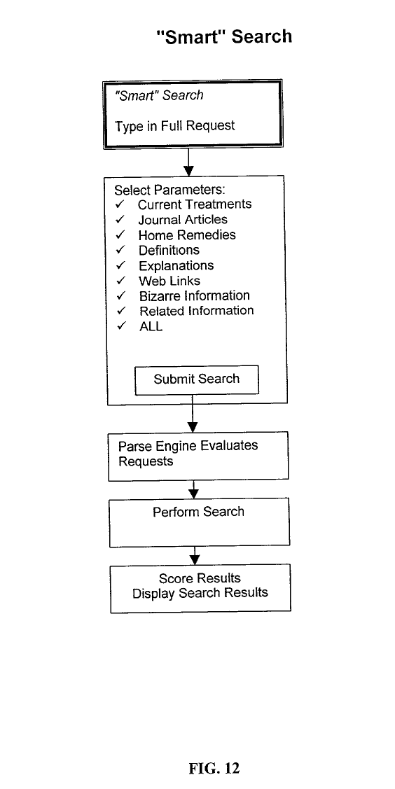

FIG. 12 shows the “smart” search process. The “smart” search window allows the user to enter a full-text search request and select specific parameters. When the user submits the search request, a “parser” evaluates that request and may return a query to help focus the search. Afterwards, an algorithmic search is performed using the ELICIT™ model to rank the search results in order of highest relevance according to the search parameters entered.

The inventive system also includes a personalized “virtual doctor” interface with selectable physician personality profiles. Basically, all queries are accordingly “tempered” for the selected physician's personality, and reflect general characteristics such as humorous, informative, concise, etc. The “virtual doctor” interface prompts the user to enter basic personal and health information (age, sex, etc.), select a virtual doctor personality, and set personal (user) response rankings. The interface recognizes the selection, and accesses the query object database (“QOD”) for that selection. All personality queries are stored as part of the base query database, and other personality traits are manipulated within the program. For the general user, this information cannot be retrieved again, and must be re-entered each time the site is accessed. Hence, registration is recommended and desired.

Setting the response rankings is another innovation of the present invention, and makes the online physician emulator more accurate. FIG. 8, discussed in detail above, shows the process of selecting the user response values or rankings. Additional accuracy is achieved By introducing such graded values or “fuzziness” into the system. Again, the salient concept is that user responses to particular queries, vary among users, and that certain responses represent different meanings among such users or consumers. For example, the response “maybe” could be more of a “yes” to one individual and more of a “no” to another. In “fuzzy” number terms, a “yes” represents a one (“1”), and a “no” represents a zero (“0”). A “maybe” might represent, 0.5, 0.4 or 0.6, depending on the particular user. Thus, the user response value editor/window allows any user to establish personalized, graded responses. This unique and novel attribute of the present invention is significant, because the program uses the user responses values/rankings as modifiers of the expert-provided primary bias values, creating a more accurate decision (e.g., diagnosis).

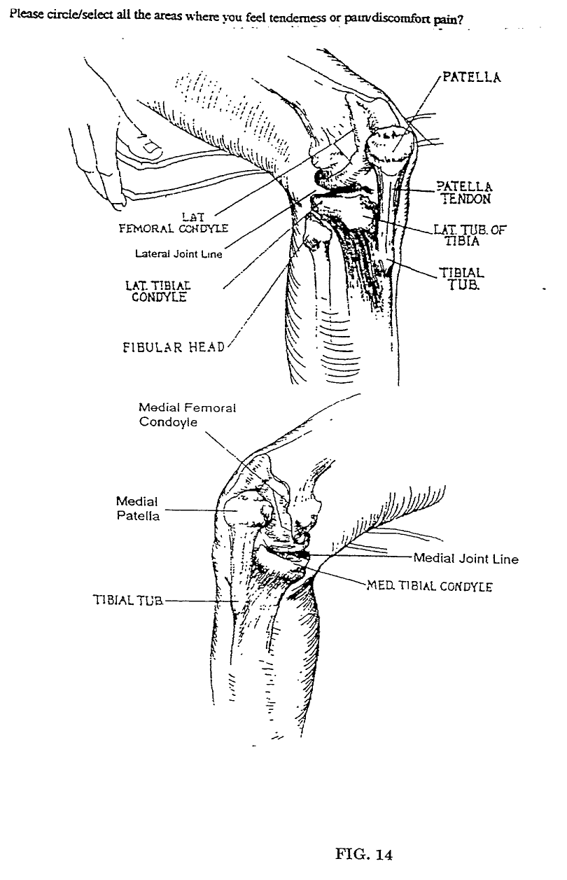

After basic health information, “virtual doctor” personality profile, and user response values/rankings have been established, the user is shown a general window where they can select a medical specialty area that most closely represents the condition or malady the user is experiencing (see FIG. 10). The general form of the window comprises selectable “buttons” that are labeled with the specific area or specialty (e.g., bone and muscle/orthopedics, rashes and skin problems/dermatology, etc.). Once a specific area is selected, the user is prompted to select a specific area of the body (i.e., location) where the pain or malady is generally located (see FIGS. 10 and 14). In some cases, the program will prompt for additional areas to be selected, and as the queries are presented in a “virtual doctor'” interview, the user will be asked to select areas of tenderness, swelling, and other body-specific symptoms (see FIG. 14).

The Online Physician Emulator process begins with the “patient initial interview” process. Queries (Qₓ) are presented, and the user is asked to select a Response (R) to each Query (Q). Each set of Queries is in a standard order based on consensus by one or more experts or physicians who supply the relevant queries for each diagnostic area, or malady area.

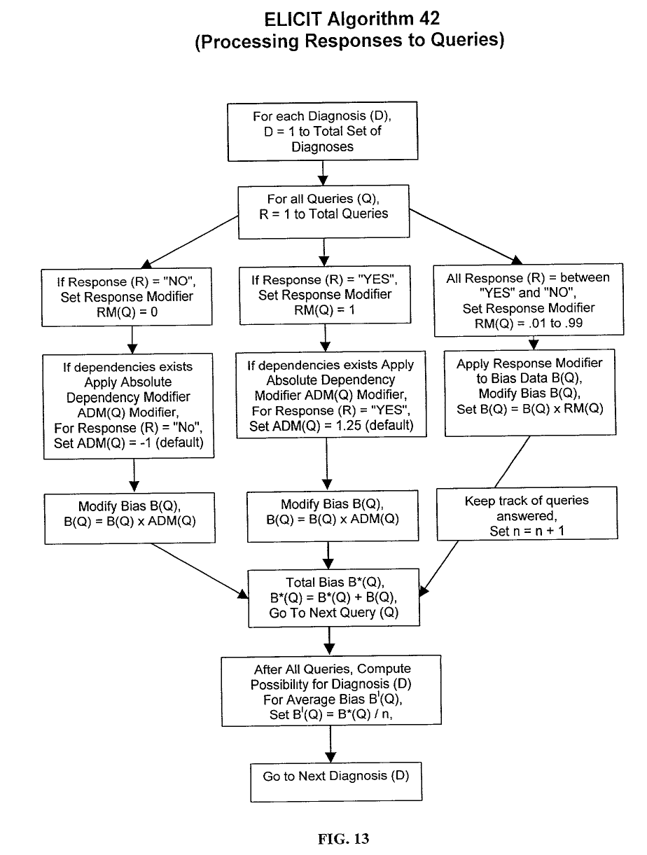

FIG. 13 shows how user responses to query sets are processed according to the present invention. After all the responses (R_{z}) have been submitted by the user, the system's novel algorithm evaluates the responses for the specific diagnostic conditions and location. When the calculations are finished, a list of the top (according to relative likelihood) 3 or 4 diagnostic possibilities are displayed in a new window. All the responses and evaluations are stored as a history for the user to reference upon return to the web site, and by the experts to validate the data set, and is used by the system to emulate stored experience, etc.

In a preferred embodiment, pictures are used, wherever appropriate, to help the user determine locations of the malady. An example of a picture useful in helping determine the area of diagnostic inquiry is shown in FIG. 14.

Diagnosis for a knee malady. An example of a diagnosis for a knee (i.e., a decision, according to the present invention), comprising a ranked (i.e., according to likelihood or possibility) set of alternative diagnoses is shown if Table II below:

TABLE II

| % Possibility | Conditions Diagnosis |
|---|---|
| 92.5 | ACL Tear |
| 78.5 | Patella Dislocation |
| 41.4 | MCL Sprain |
| 23.05 | Degenerative Arthritis |
| 13.9 | Inflammatory Arthritis |

Once a user has obtained a decision (as in the above example) comprising a ranked (according to relative likelihood) set of alternate possibilities (i.e., alternate diagnoses) the user can optionally select a particular ranked diagnosis to further investigate, and obtain additional relevant information. For example, the user may obtain information such as definitions, causes, and treatment of a particular ranked diagnosis:

DEFINITION: Antedor Cruciate Ligament Tear. The antedor cruciate ligament is one of the four main ligaments in the knee. Together with the posterior cruciate ligament, it helps to control the anterior/posterior (forward and back) movements of the femur and tibia. It is the main supplier of stability in twisting movements in sports. Unfortunately, it is frequently injured.

CAUSES: The anterior cruciate ligament (ACL) often succumbs to twisting injuries. For example, if the right foot is planted, and the body rotates to the left or right, the ACL can be torn. The ACL can be injured by hyper-extending the knee as well (this can also injure the posterior cruciate ligament). Stress applied to the inside or outside of the knee, such as when a runner is struck by a helmet on the side of his knee, can tear a collateral ligament and then the anterior cruciate ligament. If stress is applied to the outside of the knee, a tear of the medial collateral ligament, the anterior cruciate ligament, and the lateral meniscus may result. If the anterior cruciate ligament is torn, the person usually experiences immediate pain and swelling. Frequently a pop or snap is felt. Walking may be difficult, and the knee may feel unstable, as though it will give way. The knee may be difficult or impossible to straighten out due to the swelling.

TREATMENT: Treatment of an ACL tear initially involves icing and elevating the knee higher than the heart. Attention should be sought from a medical professional. With a swollen, stiff knee, an x-ray is probably indicated to rule out a fracture. An immobilizer is usually applied to prevent any further injury. An orthopedist is needed to evaluate the patient when an ACL tear is suspected. The knee is manipulated to test for stability and a treatment plan is determined. An MRI scan may be necessary to better visualize the extent of injury to the ACL and associated structures.

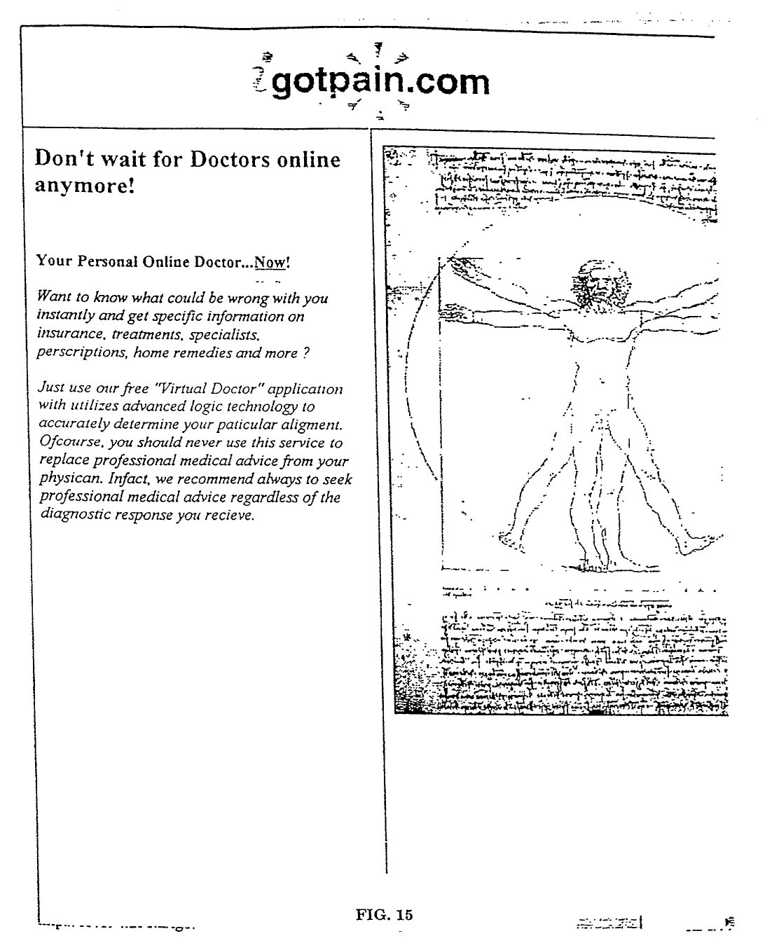

In a preferred embodiment, the system is applied to an interactive format accessible to the general public via a network on the Web, such as on the Internet. FIG. 15 shows a sample screen shot of the Online Physician Emulator (OPE). In an alternative embodiment, the system uses tangible test data to further narrow the diagnosis.

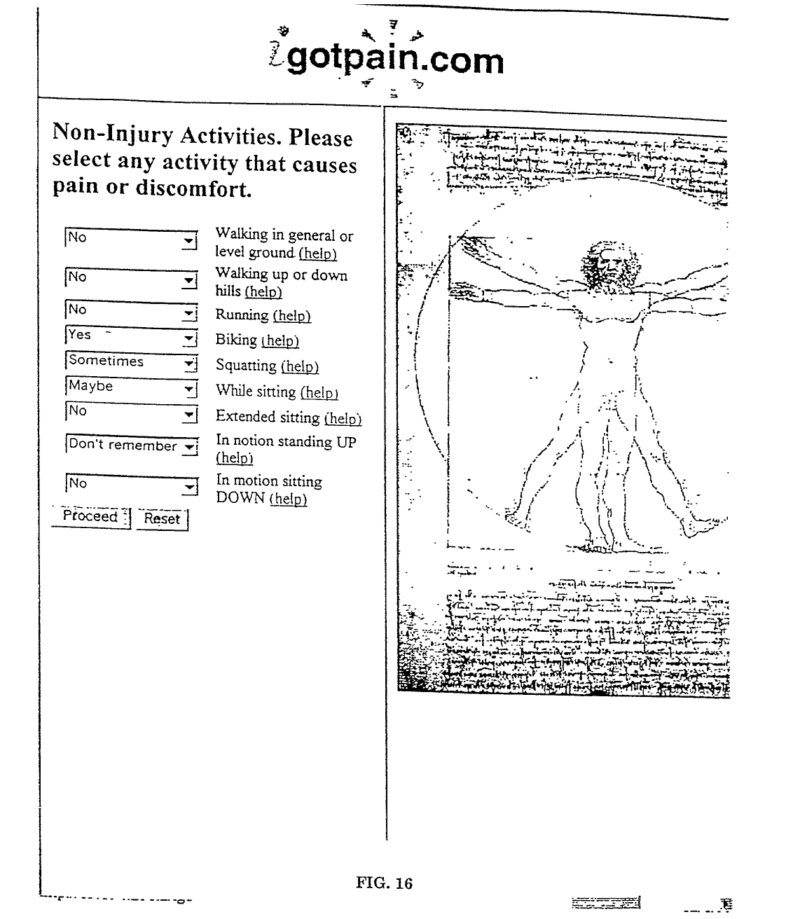

FIG. 16 shows a sample interview and diagnosis, as shown on a web page. A sample Interview or query set that may be asked of a user is as follows: How do you feel?; Where does it hurt?; Does it hurt when you move this way?; Let me examine you . . . ; Where is it tender?; How tender it is it?; Ok, from what you have told me I think you have an [decision/diagnosis], Let me tell you more about it (i.e., treatment, home remedies, drugs, insurance, etc.).

In preferred embodiments, the system is implemented as a full, interactive service, linking the diagnosis to “smart” information (see herein below) on treatment, causes, care, insurance, drugs, specialists, etc. The ranked diagnoses are hyper-linked, allowing the user to “click” and obtain more information on particular diagnoses. Accordingly, users are led to additional windows where they can learn about cures, treatments, drugs, home remedies, exercises, therapies, and other related information. Along with information the user also can access related health services, health insurance, physicians directory, appointments with specialists, and other related services (see FIGS. 10 and 5). Other features include, e.g., printing a coupon for a non-prescription drug for a local pharmacy, obtaining directions to that pharmacy, and interaction with a insurance-plan physician directly over a secure connection, allowing the physician to prescribe to the user online. FIG. 5 schematically illustrates the “End Implementation” of the present invention.

Using ELICIT™ and “Algorithm 42” (see Example 1 below) in emulating the physician decision-making process has resulted in accurate diagnoses of symptoms. ELICIT™ can be used in all medical and health specialties. The process is innovative and unique. There are layers of processes that have been standardized to allow efficient and rapid implementation of the invention and its content. These processes include gathering expert data, developing data concept standards within each specialty that will reflect adaptive uses of fuzzy logic. Additionally, other processes include the inputting, editing and testing of the expert data both through experimental prototypes and on the Web.

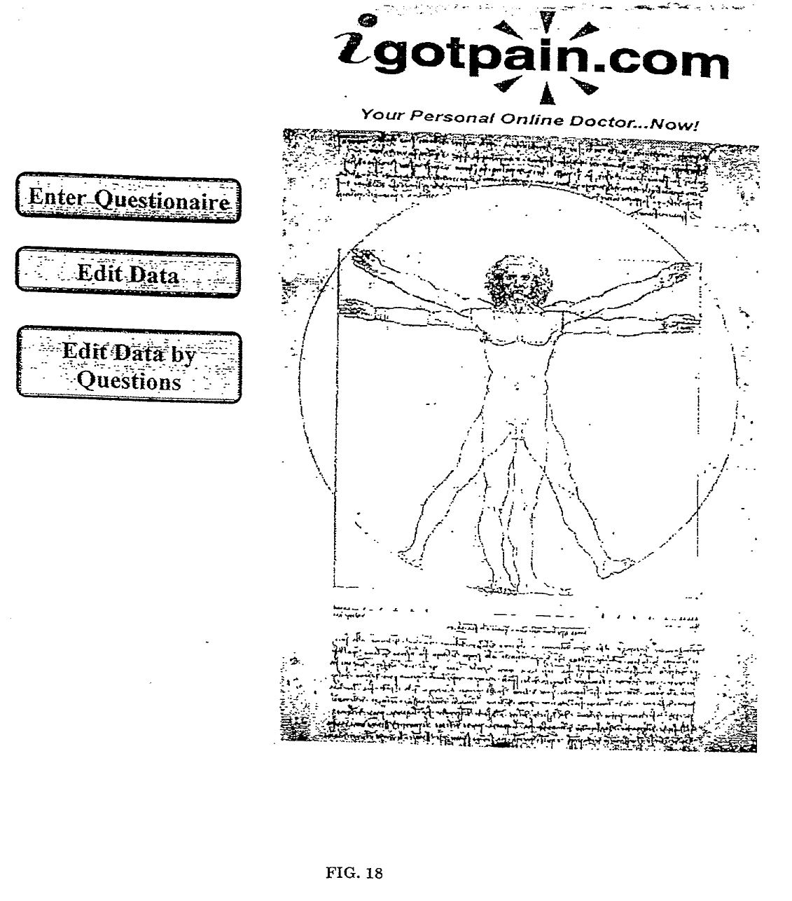

Editing of expert data. The expert data can be edited and modified. FIG. 18 shows an expert data editing screen. An expert logs in and optionally enters a sample questionnaire, and evaluates and edits data if necessary.

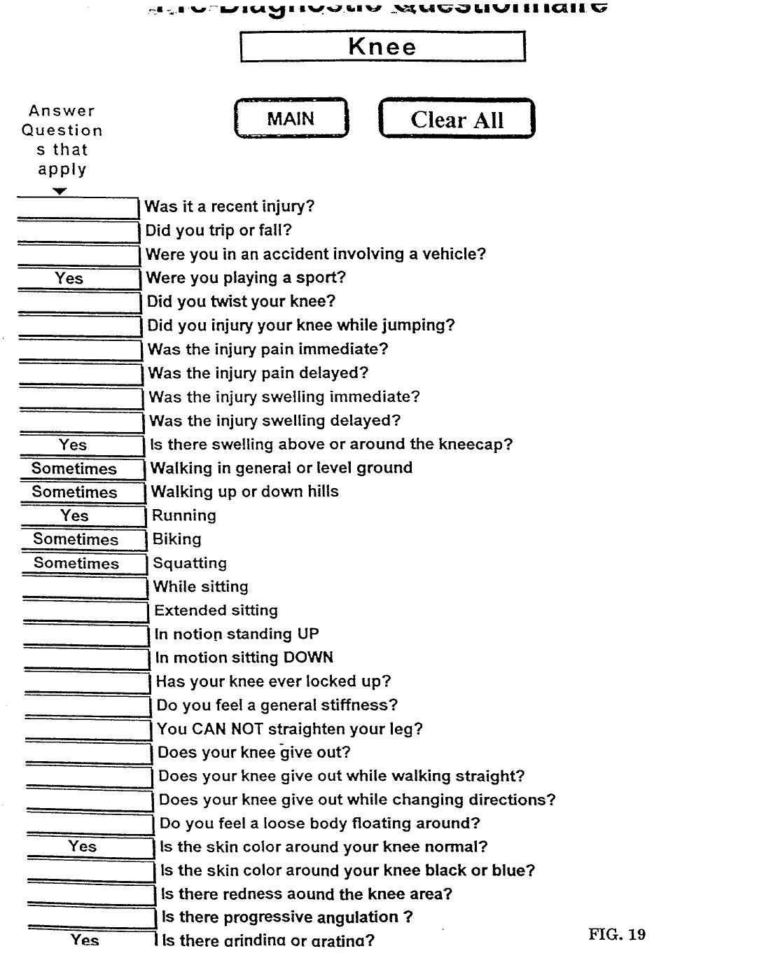

FIG. 19 shows a sample list of possible modifiable queries.

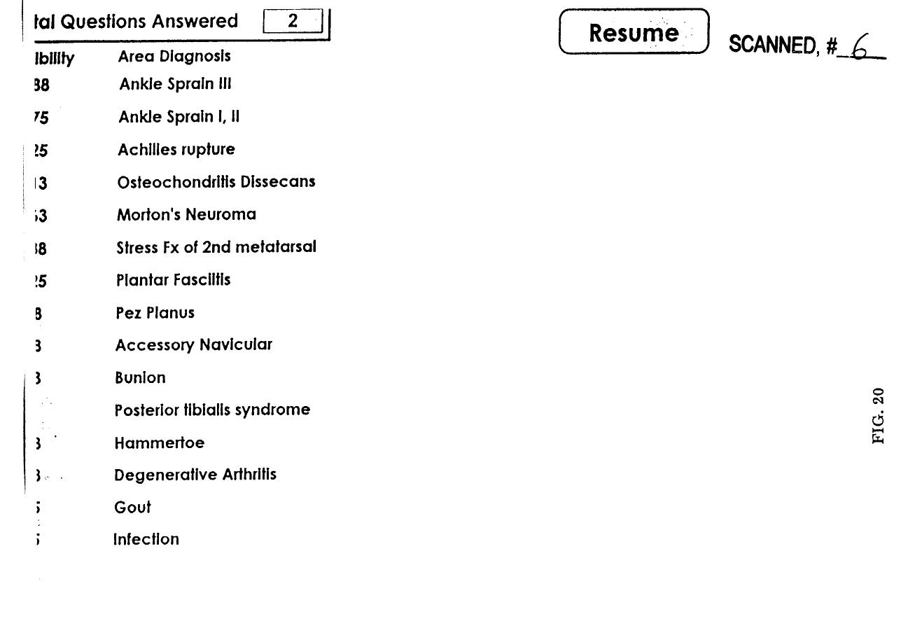

FIG. 20 shows a sample evaluation of the queries that were tested.

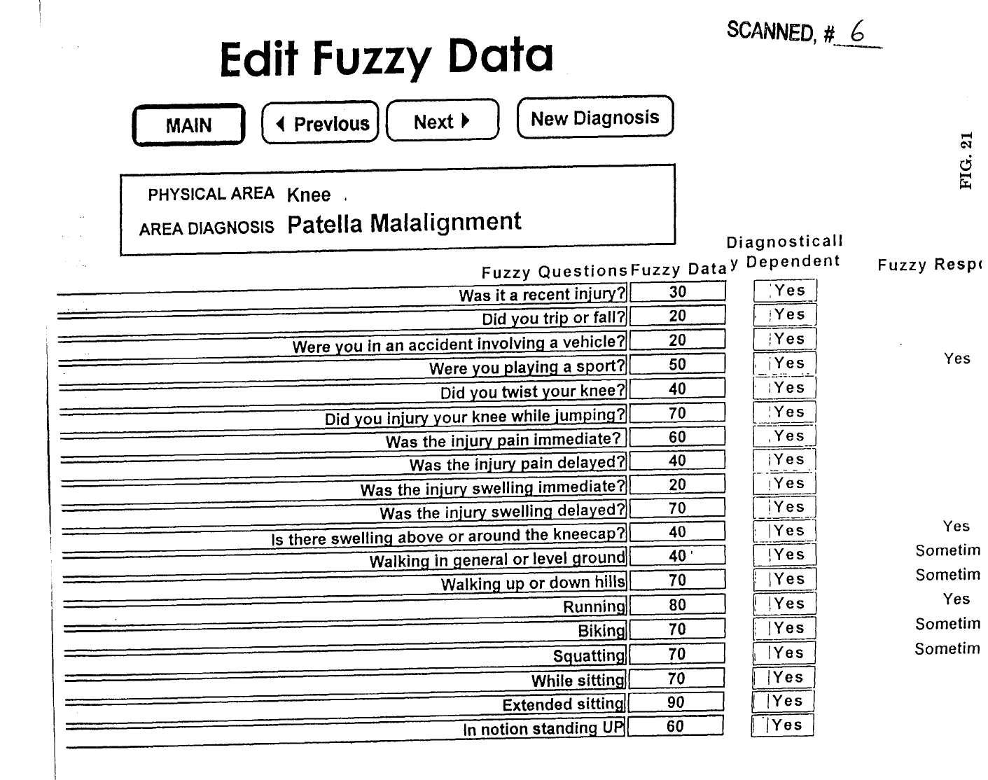

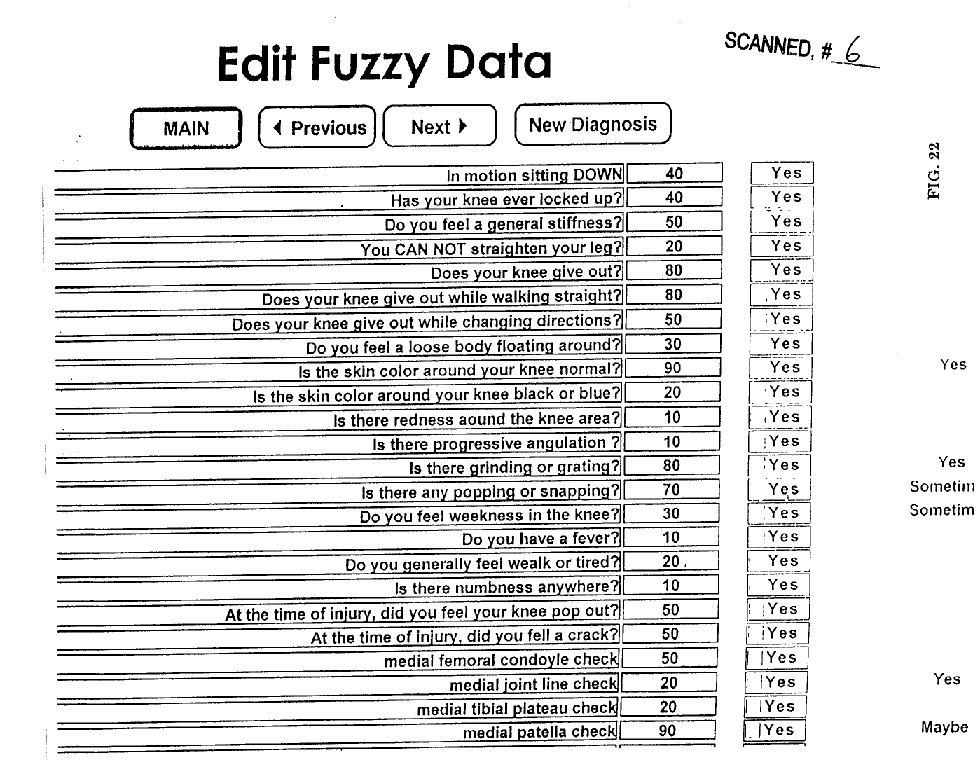

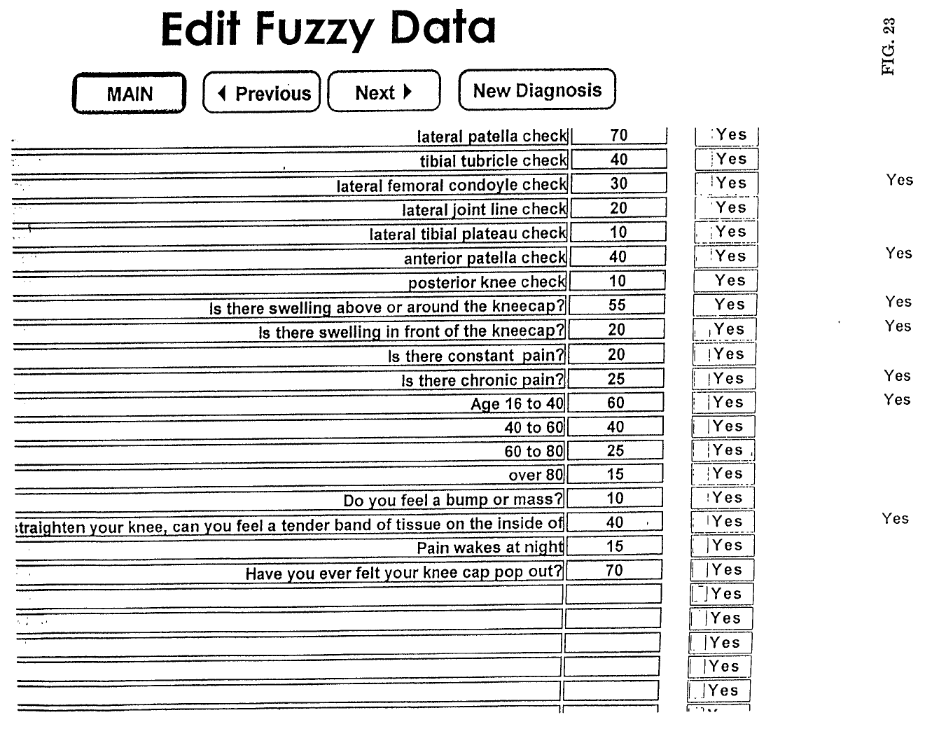

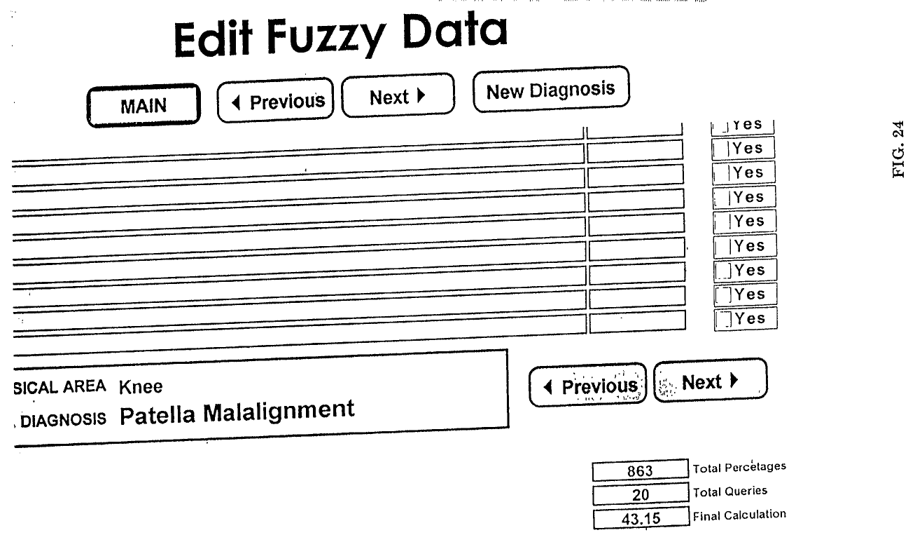

FIGS. 21-24 show contiguous portions of an edit data screen according to the present invention. Such edits screens provide an interface where the expert can change the format of the query (left column), the primary bias data associated with the query (middle column values), and determine other variables, such as whether a diagnostic dependency exists for a particular query/diagnosis relational pair (i.e., by checking one or more boxes in the right column).

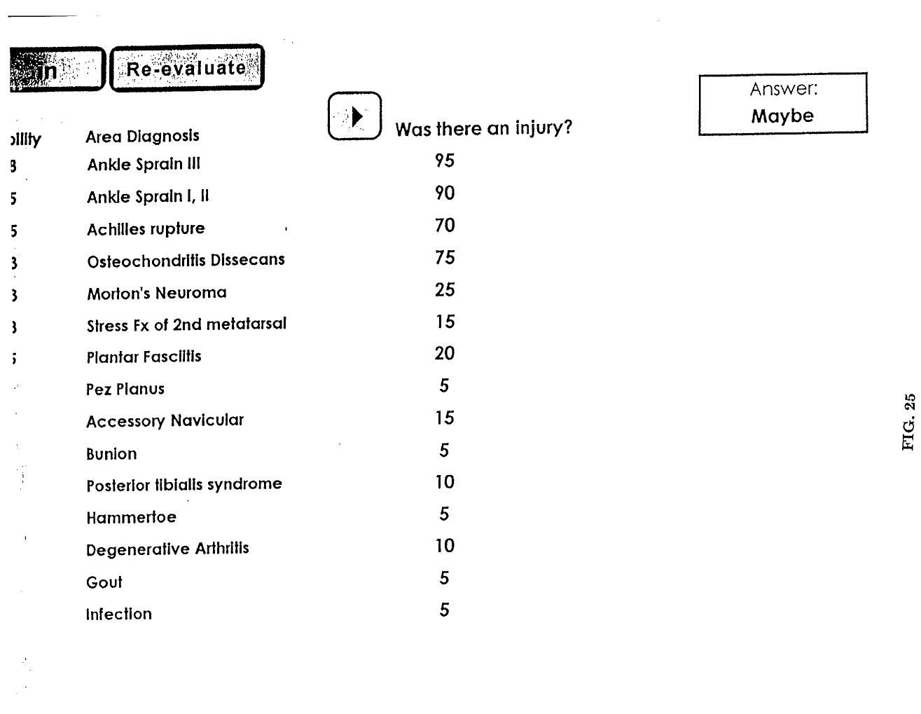

FIG. 25 shows how an expert can modify, according to the present invention, the primary bias data for one or more particular query/diagnosis relational pairs, query, and reevaluate the possibility values immediately after said modifications to test the possible ranking of the alternatives, or diagnoses.

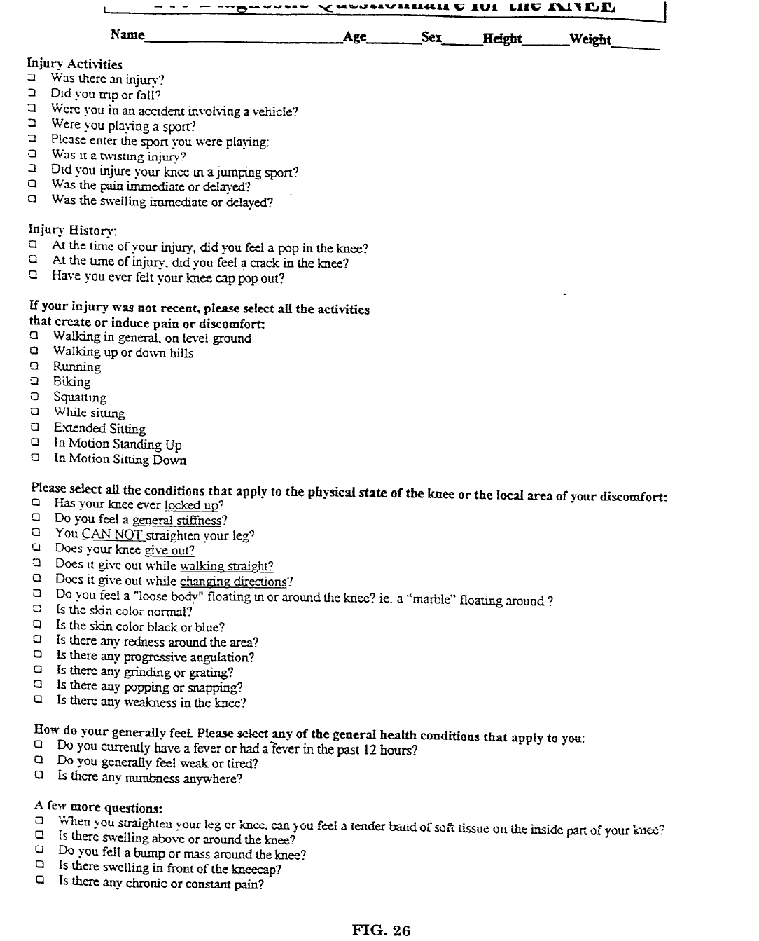

FIG. 26 shows an example of a “Pre-diagnostic Questionnaire,” according to the present invention, that is used to evaluate and test actual data in the field, such as in clinics and hospitals to generate a diagnoses.

Expert data can be gathered from an individual expert or a group of experts. Only one expert is needed to initially provide the primary Bias Data and to modify it for accuracy. That individual expert or group of experts is reviewed in the ELICIT™ concept, and educated in the use of the expert applications. The expert must first understand the method and concept of entering expert data particular to this invention to provide appropriate primary Bias Data needed to fulfill the algorithmic and logic requirements. All the data is initially developed and gathered using an array format with queries on one axis and diagnosis or conditions on another axis.

Criteria are used for the development of a query set, and standardization of query sets (sub sets). Queries must be relevant to the determination of a diagnosis or condition in the condition set, and must be comparatively valuable (relevant) between or among the diagnoses. The query tests for a symptom, an event or condition. The query can be direct or indirect. The query can be grouped in a subset of predefined symptom groups, event groups or conditional groups. The query can be clearly evaluated for the set of diagnoses (i.e., the possibility set).

In an alternate embodiment, the format and the implementation of the system in software is to base the storage of the query data using the Query Object in Database (“QOD”). The QOD will contain the full text of the query, explanations, media objects such as video clips and sound, physician personality profile characteristics, and especially the primary Bias Data for each related Diagnosis.

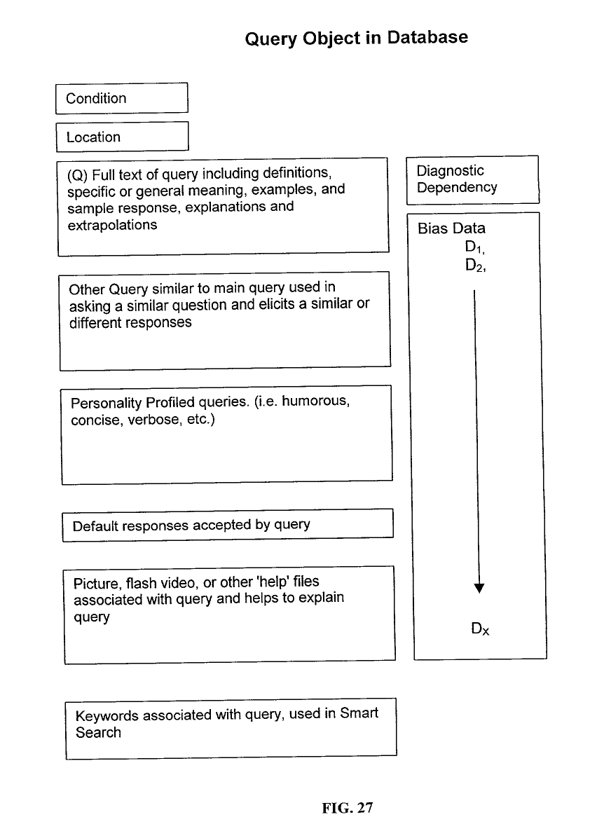

FIG. 27 shows the format of a Query Object in Database (“QOD”), according to the present invention. This figure illustrate a method for storing the primary Bias Data (B), Queries (Q) and the alternatives or diagnoses (D) in a relational database. The flexibility of incorporating new data and concepts, and associating information and allowing update is represented in the QOD approach. The query represents a single and primary test between alternatives and plays a key factor in linking information necessary in decision-making. Here, all forms of information relating to a query, variations on the query itself, primary Bias Data (B), diagnostic dependencies(“ADM”), personality profiled queries, expert-inputted default responses to a particular query, voice, video, keywords and other types of related information are stored in the QOD.

Primary bias values. Heuristic smooth data or comparative scalar data is used as primary Bias Data (Bd). The primary Bias Data reflects the expert's conception of the relative degree of predictive value of the query for the particular alternative relative to other alternatives in the possibility set (i.e., how much a symptom applies to a particular diagnosis (D)), and is established for each query (O)/diagnosis (D) pair and is then modified by the user response value (R). The Bias Data must comparatively reflect the relative predictive value between or among all the diagnoses in the set of diagnoses, and thus weigh the importance and value of the query to the diagnosis. In essence, primary bias values reflect objects of the expert's experience, and capture the expert's conceptual “bias” for a particular condition. The knowledge represented by the primary bias value is implicit rather than explicit. In the preferred embodiment, a scale of 0 to 100 is used to evaluate and determine the comparative value of the primary Bias Data. In alternative embodiments, a different scale is used, the scale having a range. The primary Bias Data is scalar and modifiable.

The relative values of the primary bias values are chosen to reflect the degree of predictive value, of the non-negative (i.e, non-zero) response to a given query, for the corresponding alternatives.

Absolute dependencies. An absolute dependency is established, by a expert or experts, between a query and a particular diagnosis if the query is particularly valuable or informative with respect to the outcome or determination of a particular diagnosis. That is, an absolute dependency is established/invoked if an absolute negative response or an absolute positive response by the user to a query is vital to the accuracy of a particular diagnosis. Absolute dependencies reflect the fact that there are some queries (Q) that have substantial importance on a particular diagnosis relative to others. Accordingly, for example, an absolute positive response (+R) to a query, for which an absolute dependency is assigned for a particular diagnosis, significantly shifts the weighted average score for this diagnosis relative to others, for which no dependency has been assigned for the query. This process has the effect of amplifying responses that are particularly informative for a particular diagnosis.

Expert data is converted to a data format that is read by the system. In the preferred embodiment, the conversion of the primary Bias Data from an array or a spreadsheet format is done utilizing a “script” (see Example 1 above). The process includes exporting prototype data into a text file so that the Web CGI script can parse the data.

In the preferred embodiment, the system=s algorithms are implemented on the Web using Perl and CGI. The conversion of the algorithm and ELICIT logic to the Web is done using Perl and CGI script, and will be familiar to those skilled in the relevant art. The program is standardized to utilize data sets.

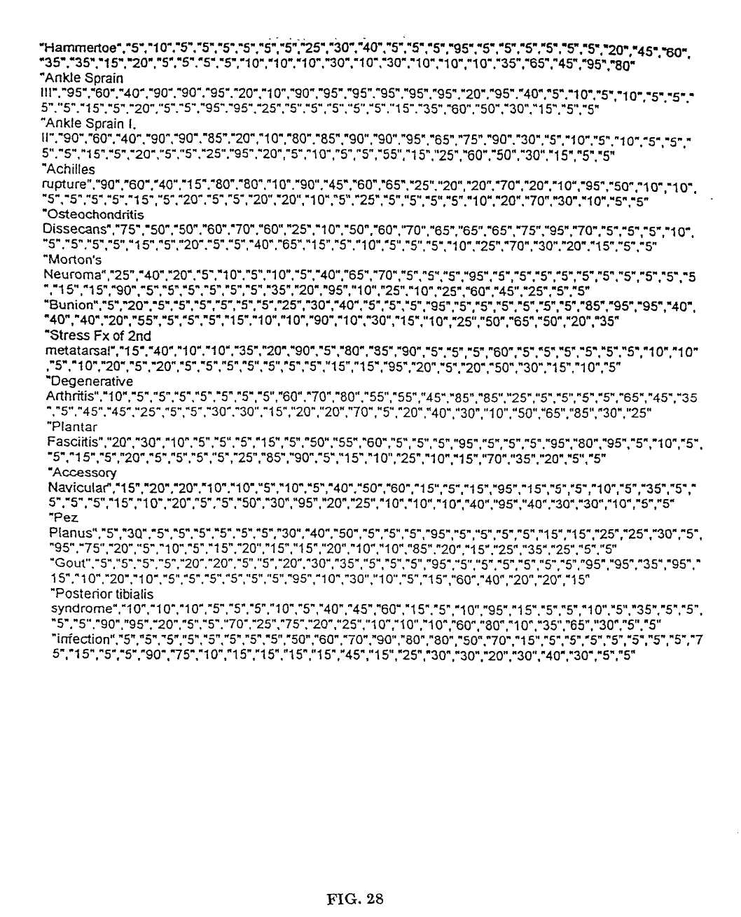

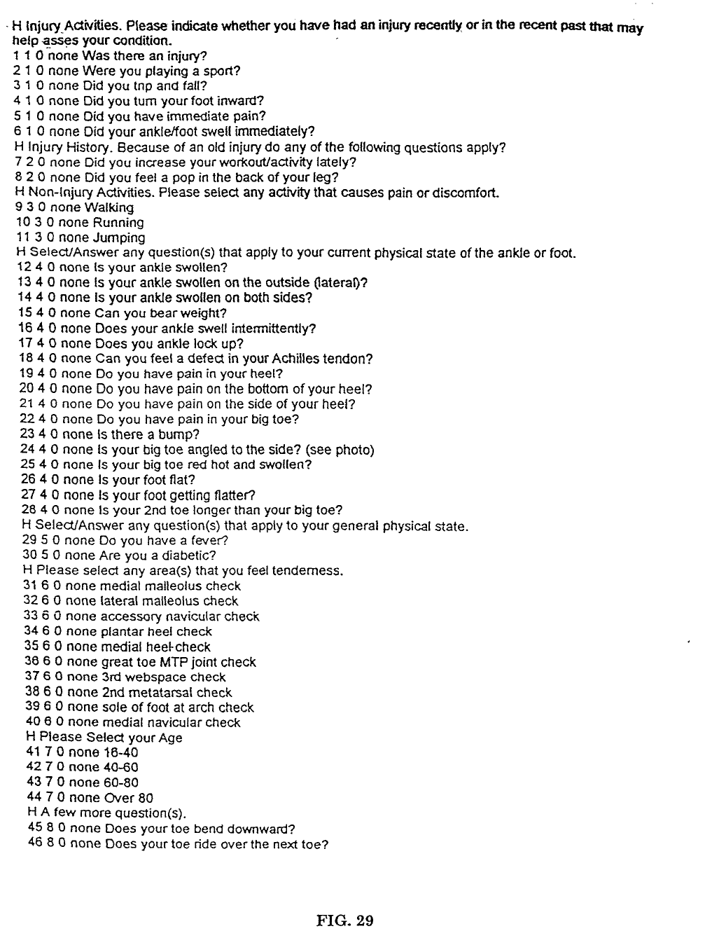

FIGS. 28 and 29 show the format of the static ELICIT™ data sets for CGI (Common Gateway Interface scripting language) scripts. Each data set represents a condition or location of a malady, and all the diagnoses for that condition, and all relevant queries, dependencies and logic coefficients.

An example of the program script, in Perl script, is included in Appendix A. The program is used by the CGI server to process the systems data sets.

Novel “Smart” search function based on “fuzzy logic” and “knowledge-based system” concepts

As discussed above, user can obtain targeted information related to particular ranked diagnoses. To accomplish this, the system applies variations of “fuzzy logic” and “knowledge-based system” concepts to the ranked diagnostic results, based on inputted and selected search parameters. In this way, a comprehensive, yet narrow range of relevant information is obtained, based on how and what was desired as part of the search, causes for the diagnosis, treatments for the diagnosis, new developments in the field of the diagnosis, support groups related to the diagnosis, etc. In an alternative embodiment, the system includes an interactive search feedback loop also based on “'fuzzy logic” and “knowledge-based” concepts. After information has been entered for a search, the interactive response issues a query to help narrow and/or develop the search criteria further, and obtain “smart” information. Alternately, the system uses text “parsing” technologies, familiar in the art, in conjunction with “fuzzy logic” and “knowledge-based system” concepts to intuitively evaluate and determine actions on whether to initiate queries and/or display particular “smart” information. FIG. 12 shows the inventive “Smart” Search process. The system applies parsing technology to further improve “interactive” quality, and enhance faster and intuitive information gathering. A statement/query entered by a user is parsed, and an appropriate response is determined: get information; begin the diagnosis query; or purchase products.

### EXAMPLE 1

Novel algorithm for emulating a physician's decisions using ELICIT™ data sets and ELICIT™ rules

This example discloses an algorithm (“Algorithm 42”), which uses ELICIT™ data sets and ELICIT™ rules to process user responses to arrive at a decision, comprising a ranked set of alternate possibilities (e.g., a ranked set of alternate diagnoses). “Algorithm 42,” and “fuzzy” ELICIT™ data sets and ELICIT™ rules are used to rank alternate possibilities according to likelihood.

ELICIT™ data sets and ELICIT™ rules, as discussed herein above and below, are used in algorithms of the present invention to emulate how a physician extrapolates patient responses to arrive at a diagnosis. Like any person, a physician weighs patient responses as they are being received, and calculates and evaluates whether each response indicates an acceptable “guess” as to the conclusion of the diagnosis, or if more queries should be asked, and whether additional queries will help further evaluate the response. The ELICIT ™-based “Algorithm 42” of the system is defined as follows:

Term definitions and ranges for “Algorithm 42”:

| Variable | Definition |
|---|---|
| Q = | Query, Query, Location Check, Test for Symptom, |
| | Test for Possibility |
| | (Format = Text, i.e., “Was there an injury?”) |
| D = | Diagnosis, Condition, Output, Possible Alternative, |
| | Possibility |
| | (Format = Text, i.e., “ACL Tear”) |
| R = | Response to Q, Results, Input to Query, Qualitative or |
| | Quantitative Data |
| | (Format = Text or Numeric, i.e., “Yes,” “Maybe,” “No”) |
| RM = | Response Modifier, modifies the Bias |
| | (Format = Numeric, range = 0 to N) |
| AD = | Absolute Dependency, Diagnostic Dependency |
| | (Format = Text, i.e., “ACL Tear”) |
| ADM = | Absolute Dependency Modifier |
| | (Format = Numeric, range <−1 or range >1) |
| B = | Bias - reflects the data which comparatively infers, |
| | between all Diagnoses (D), that a particular Query (Q) |
| | is relatively “more likely/relevant” or “less likely/relevant” |
| | for a particular Diagnosis (D) than other Diagnoses (D). |
| | Smooth Data, Experience, Scalar Data, Expert Data, |
| | ELICIT ™ Data Set. |
| | (Format = Numeric, range 0 to 100 or Text, a qualitative |
| | range) |

q = Q_{y}; 1 to number of queries (numeric)
d = Dₓ; 1 to number of diagnoses (numeric)
r = R_{z}; 1 to number of responses (numeric) for a particular query (Q)
r = 1; default response
RM_{q}(r) = 0; absolute negative response, when r = 1 (i.e., R = “No” or R = “Never”)
RM_{q}(r) = 1; absolute positive response, when r = total r (i.e., R = “Yes” or R = “Always”)
B (Dₓ, Q_{y}, R_{z}) = Set of Bias Data in a 3-D ELICIT ™ Data Set.
B_{d}(q) = B(d, q, r) for r = 1 (default response); (Bias Data Array, Bias for Query (Q) by Diagnosis (D))
B_{d}¹(q) = Total Sum of Bias for each Diagnosis (D)
B_{d}*(q) = Weighted Average Bias for each Diagnosis (D)

Algorthmic process for “Algorithm 42”:

| for each d: d = 1 to t: | | ;determine the possibility |
|---|---|---|
| | | for each Diagnosis (D) |
| | | t = total number of |
| | | diagnoses |
| | find | ;Total bias sum, for n = |
| | | total positive responses |
| | ${B}_{d}^{I} ( q ) = {\sum }_{q = 1}^{n} {B}_{d} ( q )$ | |
| | find | ;Average bias |
| | ${B}_{d}^{*} ( q ) = [ {\sum }_{q = 1}^{n} {B}_{d} ( q ) ] / n$ | |
| | or B_{d}*(q) = B_{d}^{I}(q)/n, | ;Average bias, for n = |
| | for q = 1 to n | total positive responses. |

| | |
|---|---|
| for each q: q = 1 to t: loop | ;for each query, t = |
| | total queries |

if R = “Yes” or “Always” or “any absolute positive responses”;

| | |
|---|---|
| set n = n + 1 | ;increment n, n = |
| | total positive |
| | responses |
| if AD_{d}(q) = D(q) | ;if de- |
| | pendency exists |
| | for diagnosis |

| | |
|---|---|
| set ADM_{d}(q) to > 1 | ;set modifier to |
| | increase possibility |
| B_{d}(q) = B_{d}(q) · ADM_{d}(q) | ;modify the bias |
| | to reflect |
| | dependency |

Else

| | |
|---|---|
| set RM_{(q)}(r) = 1; | ;absolute positive |
| | response |
| B_{d}(q) = B_{d}(q) · RM_{(q)}(r) | ;modify the bias |
| | based on response |

| | |
|---|---|
| B_{d}^{I}(q) = B_{d}^{I}(q) + B_{d}(q) | ;add bias value |
| | to total bias |

Else

if R = “No” or “Never” or “any absolute negative responses”

| | |
|---|---|
| set n = n | ;do not increment n |
| set RM_{(q)}(r) = 0; | ;absolute negative |
| | responses |
| if AD_{d}(q) '2 D(q) | ;if dependency |
| | exists for diagnosis |

| | |
|---|---|
| set ADM_{d}(q) to < 0 or −1 | ;set modifier to |
| | decrease possibility |
| B_{d}(q) = B_{d}(q) · ADM_{d}(q) | ;modify the Bias to |
| | reflect dependency |
| B_{d}^{I}(q) = B_{d}^{I}(q) + (B_{d}(q)) | ;modified dependent |
| | bias subtracted |

from total sum to
reflect a decrease in
possibility, (bias
value) is negative

Else

| | |
|---|---|
| B_{d}(q) = B_{d}(q) · RM_{(q)}(r) | ;the Bias data = |
| | 0, is not added to |
| | the sum |
| or | |
| B_{d}(q) = B_{d}(q) · 0 | ;because the result is |
| | zero, no increase to |
| | total bias sum |

Else (for R = “all other positive responses”)

| | |
|---|---|
| set n = n + 1 | ;increment n, n = |
| | total positive |
| | responses |
| B_{d}(q) = B_{d}(q) · RM_{(q)}(r) | ;modify the bias |
| | based on response |
| B_{d}^{I}(q) = B_{d}I(q) + B_{d}(q) | ;add bias value |
| | to total bias |

| | |
|---|---|
| End loop after t = total queries | |
| Calculate B_{d}* (q) = B_{d}^{I}(q)/n, | ;Average bias for d |
| Do next d | |

Algorithmic States; scalar ranges, possibility states and possibility scoring for “Algorithm 42”:

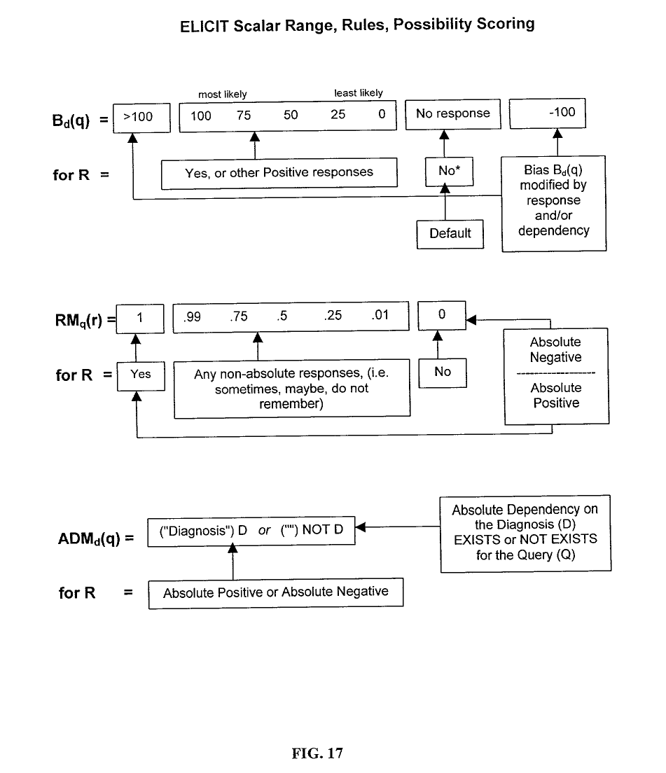

FIG. 17 shows the scalar range, rules, and possibility scoring.

The algorithmic states are:

| | |
|---|---|
| Non-dependent states | |
| Positive Response | = (B_{d}(q) · RM_{q}(r))/n; set n = n + 1 |
| Default or “No” | = (B_{d}(q) · 0)/n; set n = n |
| Dependent states | |
| Absolute Negative | = [B_{d}^{I}(q) + (B_{d}(q) · ADM_{d}(q))]/n; n = n, |
| | where RM_{q}(r) = 0, set ADM < 0 |
| Absolute Positive | = (B_{d}(q) · ADM_{d}(q))/n; n = n + 1, |
| | where RM_{q}(r) = 1, set ADM > 1 |

Script implementation of “Algorithm 42”:

The implementation of the algorithm in script is as follows:

Reset queries responded, set n = 0
Reset average bias for next diagnosis, set B_{d}*(q) = 0
Reset current response to not responded, default of absolute negative; set RM_{q}(r) = 0
For each diagnoses d = 1 to total diagnosis, calculate possibility until d = total diagnoses
Loop

For each query q = 1 to total queries, check responses until q = total queries

If current response to query = “yes” or “always” or “any absolute positive response”

Add 1 to (queries) queries responded
Check for dependency
If dependency exists

Set dependency modifier to > 1;

(Default = 1.25, an increase of 25%)

Modify Bias by absolute dependency modifier

Else

If diagnostic dependency does not exist

Get response modifier

(Default = 1, for absolute positive response, i.e., “Yes”)

Modify the Bias by the response modifier;

End if

End if

Else
If current response to query = “No” or “Never” or “any absolute negative response”

Note: do not add 1 to queries responded
Check for dependency
If diagnostic dependency exists

Set dependency modifier to < 0;

(Default = −1)

Modify the Bias by absolute dependency modifier
Add modified (negative) Bias to total sum of Biases, reducing sum

Else (for all other current responses that are positive)

Add 1 to queries responded
Get response modifier

(For responses =”Sometimes,” modifier = .75

“Maybe,” modifier = .45
“Don't remember” = .2)

Modify the Bias by the response modifier

End if

End if

Add Modified Bias to Total sum of Biases
Next q, until q = total responses asked
Calculate Average Possibility for Diagnosis;

Possibility = Total Sum of Biases / Total queries (queries) responded

End Loop

Sample bias data, user response modifiers, absolute dependencies and results of the related algorithmic script:

Sample bias data, user response modifiers, absolute dependencies and results of the related algorithmic script (“Algorithm 42”) are shown below:

Bias = B (Dₓ, Q_{y})

| | D₁ | D₂ | D₃ |
|---|---|---|---|
| Q₁ | 80 | 5 | 25 |
| Q₂ | 25 | 50 | 90 |
| Q₃ | 95 | 65 | 10 |

Responses Modifier = RM_{q}(r)

| | R₁ | R₂ | R₃ |
|---|---|---|---|
| Q₁ | 0 | .75 | 1 |
| Q₂ | 0 | .45 | 1 |
| Q₃ | 0 | .2 | 1 |

| | |
|---|---|
| Q₁ = “Does it Hurt?” | Possible Responses R = “No” |
| | (default), “Sometimes,” “Yes” |
| Q₂ = “Will it Hurt Later?” | Possible Responses R = “No” |
| | (default), “Maybe,” “Yes” |
| Q₃ = “Did you Hurt Earlier?” | Possible Responses R = “No” |
| | (default), “Don't Remember,” |
| | “Yes” |
| where: | |

Q₂ is an absolute dependency (diagnostically dependent on) for D₁
Q₃ is an absolute dependency (diagnostically dependent on) for D₂

| | |
|---|---|
| Response (R) to Query Q₁ = “Yes,” | response modifier = R₃ = 1 |
| Response (R) to Query Q₂ = “No,” | which is default and indicates Q₂ |
| | was not responded to; |
| | response modifier = R₁ = 0 |

Response (R) to Query Q₃=“Do not remember,” response modifier=R₂=0.2

Results of the Algorithm Script:

For D₁ or d=1;

B (D₁, Q₁)=80

B (D₁, Q₂)=−25

B (D₁, Q₃)=19

B₁^{I}(q)=80; for q=1

Because Q₂ is dependent on D₁ and is left not responded, an absolute negative ADM_{d}(q) is set to −1 for q=2

| | |
|---|---|
| Applying: | B_{d}(q) = B_{d}(q) · ADM_{d}(q) results −25 |
| Applying: | B_{d}^{I}(q) = B_{d}^{I}(q) + B_{d}(q) results in 55 |
| | B₁^{I}(q) = 55 |
| Applying: | B_{d}(q) = B_{d}(q) · RM_{(q)}/(r) for q = 3 results 19 |
| | B₁^{I}(q) = 74 |
| Applying: | ${B}_{d}^{*} ( q ) = [ {\sum }_{q = 1}^{n} {B}_{d} ( q ) ] / n ; Average$ |

B₁*(q) or B(D₁) = 37% Possibility for Diagnosis D₁ for n = 2 responded queries

Conclusion

The present invention provides a process, apparatus and method for decision making, based on emulation of the human decision-making process in ranking a set of alternate possibilities according to their relative likelihood. The inventive method relates user responses to queries or “symptoms,” according to expert-derived primary bias values to rank a set of alternative possibilities. The invention is applicable to any subject or problem area that manifests “symptoms.” Symptoms include test results, or responses to queries.

The invention does not use if-then (explicit or otherwise) rules, decision trees, probabilities or statistic-based likelihood ratios. Rather, the present invention uses conceptual primary bias values provided by an expert having implicit knowledge of the alternatives, wherein each primary bias value is associated with a particular alternative, and reflects the expert's conception, intuition and experience of the relative degree of predictive value of the query for the particular alternative relative to other alternatives in the possibility set.

The present invention is not limited to a singular state, rather it encompasses all embodiments within the scope of the invention. In an alternative embodiment of the invention, the system uses full text parsing. In yet another embodiment of the invention, the system uses voice recognition as an interface to the Online Physician Emulator.

The encompassed application platforms include not only the Internet but also, stand-alone formats for teaching hospitals where this invention can act as a “second opinion” physician. Also, the program can be used as a high-end teaching tool for medical professionals. The system can also be used in HMO settings. The system can evaluate patient's symptoms, determine the appropriate tests until a diagnosis is received and dictate prescriptions and doses for that patient. This present invention could save millions of dollars in treating misdiagnosed- and over-tested patients.

While there have been described herein what are considered to be preferred and exemplary embodiments of the present invention, other modifications of the invention shall be apparent to those with ordinary skill in the art. Therefore, it is desired to be secured in the specification all such modifications and extensions as fall with within the true spirit and scope of the invention. The invention is to be construed as including all embodiments thereof that fall within the scope of the specification. In addition, one with ordinary skill in the art will readily appreciate that other applications may be substituted for those set forth herein without departing from the spirit and scope of the present invention.

Appendix A
#!/usr/bin/perl -w
$html_title = $0;
$html_title =˜s/.*V(\w+)$/$1/;
$cgi_name = $html_title;
$html_title =˜ s/_//g;
$[ = 1;
$debug = 0;
$answercookiename = ″chaincookie″;
$answercookiefilter = ″[-0123456789:.]+″;
$levelcookiename = ″chainlevel″;
@questions_2b_asked = ( );
($num_questions,$num_conditions,$max_level) = read_dat_file( );
if ($debug) { addbody(″# questions = $num_questions, # conditions=$num_conditions, max
lvl=$max_level<br>\n″); }
($first_unanswered_question ,$level) = get_state_from_cookie($num_questions);
if ($debug) { addbody(″get_state_from_cookie:first=$first_unanswered_question,level=$level<br>\n″);}
update_state_from_form( );
$new_answercookie = join(″:″, @answers);
$new_levelcookie = $level+1;
if( $debug) {

addbody(″new_level=$new_levelcookie\n<br>″);
addbody(″new answer cookie = $new_answercookie\n″);
if ( $new answercookie =˜ /$answercookiefilter/ ) {

addbody(″new_answercookie passed filter\n″);

}

}
if ($debug) { addbody(″\n\n\n″); }
if ($level > $max_level) {

while (($diag, $factor_list) = each %condition) {

if ( $debug ) { addbody(″$diag (has factors $factor_list)<br>\n″); }
@factors = split(′,′, $factor_list);
if ( $debug ) { addbody(″$#factors items in \@factors<br>\n″); }
$score = 0; $max = 0; $num_answers=0;
foreach $factor (@factors) {

($question,$weight) = $factor =˜ /q(\d+)=(\d+\.*\d*)/;
$max = $max + $weight;
if ( $answers[$question] > 0 ) {

$score = $score + ($weight * $answers[$question] );
$num_answers++;

}
$answer = $answers[$question];
if ( $debug ) { addbody(″ pondering $question $weight. It was \″$answer\″so new score =

$score<br>\n″); }

$question++;

}
if ( $num_answers= =0 ) { $num_answers=1; }
$score = int( $score / $num_answers * 100) /100;
if ( $debug ) { addbody(″ final score = $score ($max max)\n″); }
$a{$diag} = $score;
$question++;

}
it ( $debug ) { print ″\n″; }
@unsorted = ( );
foreach $diag (keys(%a)) {

$url = $diag;
$url =˜ s/[\/]/_/g;
$url =˜ s/[′″]//g;
$url = ″http://adsl-63-194-251-2.dsl.lsan03.pacbell.net/igotpain/$cgi_name/$url.html″;
@unsorted = ( ″$a{$diag}\t\t<a href=\″$url\″TARGET=\″reference\″>$diag</a>\n″, @unsorted);

}
if ( $debug ) { addbody(″</PRE>\n″); }
addbody(″<PRE>\n″);
addbody( ″% Possibility\tCondition\n″);
addbody(reverse(sort sortdiags @unsorted));
addbody(″</PRE>n″);
if ( $debug ) { addbody(″</PRE>\n″); }
addbody(″(Back to <A HREF=\″/igotpain/welcome.html\″ TARGET=\″reference\″>vitruvian man</A>)″);
if ( $debug ) { addbody(″<PRE>\n″); }
$new_answercookie = ″″;
$new_levelcookie = ″″

}

else { # ask another set of questions

if ($debug) { addbody(″</PRE>\n″); }
addbody(″<FORM method=\″POST\″ action=\″/cgi-bin/igp/$cgi_name\″>\n″);
@questions_2b_asked = build_question_list($level, $max_level, $first_unanswered_question,

$num_questions);

$new_answercookie = join(″:″, @answers);
$new_levelcookie =0 level+1;
if( $debug ) {

addbody(″new_level=$new_levelcookie, old_level=$level\n<br>″);
addbody(″new answer cookie = $new_answercookie\n″);
if ( $new_answercookie =˜ /($answercookiefilter)/) {

addbody(″new_answercookie passed filter\n″);

}

}
$current_header = ″″;
foreach $qdata (@questions_2b_asked) {

($qnum,$level,$depend,$help_ref,$question,$qheader) = split(″xyzzy″,$qdata);
if ( $current_header ne $qheader ) {

$current_header = $qheader;
addbody(″<TABLE BGCOLOR=\″#A0A0A0\″><TR><TD ALIGN=\″LEFT\″

COLSPAN=2><H2>$current_header</H2></TD></TR>\n″);

}
addbody(″<TR>\n″);
addbody(get_question_html(″q$qnum″,$question,$help_ref,″no″));
addbody(″</TR>\n″);

}
addbody(″</TABLE>\n″);
addbody(″<input type=\″submit\″ value=\″Proceed\″>\n″);
addbody(″<input type=\″reset\″>\n″);
addbody(″</FORM>\n″);
if ($debug) { addbody(″<PRE>\n″); }

}
sub sortdiags {

($aa) = split(″\t″,$a);
($bb) = split(″\t″,$b);
#$aa = sprintf(″%3.4d″,$aa);
#$bb = sprintf(″%3.4d″,$bb);
($aa<=>$bb)

}
############
###
### do the printout
###
############
&printheader($new_answercookie,$new_levelcookie);
printhtml( );
exit 0;
#XXXXXXXXX
sub build_question_list {

local ($last_lev, $max_lev, $first_q, $last_q) =@_
local ($qlevel,$qdepend,$dep_qnum,$dep_answer);
@qlist = ( );
if ($debug) { addbody(″in build_question_list(last=$last_1ev, max=$max_lev, first=$first_q,

last=$last_q)\n<br>″); }

foreach $qnum ( $first_q..$last_q ) {

if ( $answers[$qnum] != −1) {

if ($debug) { addbody(″q#$qnum skipped<br>\n″); }
next;

}
($iqnum,$qlevel,$qdepend) = split(″xyzzy″,$q[$qnum]);
if ($debug) { addbody(″qnum = $iqnum($qnum); qlevel = $qlevel; qdepend = $qdepend<br>\n″); }
($dep_qnum,$dep_answer) = $qdepend =˜ /(d+)([+−]*)/;
if ( $dep_answer =˜/\+/ ) { $dep_answer = ″1″; }
if ( $dep_answer =˜ /−/ ) { $dep_answer = ″0″; }
if ($debug) { addbody(″answers[$dep_qnum]=$answers[$dep_qnum], dep_qnum=$dep_qnum,

dep_answer=$dep_answer<BR>\n″); }

if ( $qlevel = = $last_lev ) {

if ( $dep_qnum = = 0 || $answers[$dep_qnum] = = $dep_answer ) {

push(@qlist,$q[$qnum]);
if ($debug) { add body(″pushed $q[$qnum]\n″); }

}

}

}
if($debug ) {

addbody(″build question_list = \n″
foreach $line (@qlist) { addbody(″$line\n″); }

}
@qlist;

}
sub update_state_from_form {

$n = <> ;
$n = ″″unless ($n);
if ( $debug ) { addbody( ″STDIN: $n\n<br>″); }
@question_answer = split(/&/, $n);
foreach (@question_answer ) {

if ( $debug ) { addbody(″$_:″); }
if ( /q(\d+)=(\w+)/ ) {

($qnum,$val) = ($1 ,$2);
if ( $debug ) { addbody(″$qnum => $val\n″); }
if ($val eq ″yes″) { $answers[$qnum] = 1; }
if ($val eq ″sometimes″) { $answers[$qnum] = .75; }
if ($val eq ″maybe″) { $answers[$qnum] = .45; }
if ($val eq ″unknown″) { $answers[$qnum] =.2; }
if ($val eq ″no″) { $answers[$qnum] = 0; }

}
if ( $n =˜ /R=yes/ ) { $answers[$qnum] = −1; }

}

}
sub read_dat_file {

local ($number_of_questions,$number_of_conditions,$max_lev) = (0,0,0);
local ($line,$condition_name,$factors) = (″″,″″,″″);
local ($qnum,$qlevel,$depend,$help_ref,$question,$current_header) = (0,0,″″,″″,″″,″″);
open(DAT, ″<$cgi_name.dat″) || die(″test.dat unreadable\n″);
@dat = <DAT>;
close(DAT);
foreach $line (@dat) {

if ( $line =˜ /\hat{ }″([\hat{ }″]+)″,(″\d+″,″\d+,.*)$/) {

if ( $debug ) { addbody(″\n < br > condition line: $line″); }
($condition_name, $line) = ($1,$2);
$number_of_conditions ++;
$line =˜ s/″//g;
@factors = split(/,/,$line);
foreach $n (1..$#factors) { $factors[$n] = ″q$n=$factors[$n]″; }
$factors = join(″,″,@factors);
$condition{$condition_name} = $factors;
if ( $debug ) { addbody(″\%condition $condition_name = $factors″); }

}
elsif ($line =˜ /\hat{ }(\d+) (\d+) (\d+]+ −]*) (\w+) (.*)/) {

if ( $debug ) { addbody(″question line: $line″); }
($qnum,$qlevel,$depend,$help_ref,$question) = ($1,$2,$3,$4,$5);
$q[$qnum] = join(″xyzzy″,($qnum,$qlevel,$depend,$help_ref,$question,$current_header));
$number_of_questions ++;
if ( $qlevel > $max_lev ) { $max_lev = $qlevel; }

}
elsif ( $line =˜ /\hat{ }H (.*)/ ) { $current_header = $1; }
else {

if ( $debug ) { addbody(″unprocessed line:\n$line\n″); }

}

}
if ( $debug ) {

addbody(″number_of_questions = $number_of_questions, number_of_conditions =

$number_of_conditions, max_lev = $max_lev\n″);

}
($number_of_questions,$number_of_conditions,$max_lev);

}
### Cookies ####
sub get_state_from_cookie {

local ($qnum) = @_;
local ($first,$qlevel) = (1,1);
$env_cookie = $ENV{HTTP_COOKIE};
if($debug) {

addbody(″env_cookie = $env_cookie \n″);
addbody(″cookiefilter = $answercookiefilter \n″);

}
if ( $env_cookie =˜ /$answercookiename=($answercookiefilter)/ ) { $cookie = $1; }
if ( $env_cookie =˜ /$levelcookiename=(\d+)/ ) { $qlevel = $1; }
if ( $debug ) { addbody(″filtered cookie = $cookie\n″); }
if ( $cookie) {

@answers = split(/:/, $cookie);
until (($answers[$first] = = −1) || ($first > 80) ) { $first ++; }

}
else {

foreach $n (1..$qnum) { $answers[$n] = −1; }
$first = 1;
if ( $debug ) { addbody(″initialized $qnum answers to −1\n″); }

}
($first, $qlevel);

}
### HTML stuff ###
sub get_question_html {

local ($name,$question,$help,$default) = @_;
local ($html, $yeschecked, $nochecked) = (″″,″″,″″);
if ( $default eq ″yes″) { $yeschecked = ″SELECTED″; }
if ( $default eq ″no″) { $nochecked = ″SELECTED″; }
$html = ″\
<TD ALIGN=\″CENTER\″>\
<SELECT NAME=\″$name\″>\
<OPTION $yeschecked VALUE=\″yes\″>Yes\
<OPTION VALUE=\″sometimes\″>Sometimes\
<OPTION VALUE=\″maybe\″>Maybe\
<OPTION VALUE=\″unknown\″>Don\'t remember\
<OPTION $nochecked VALUE=\″no\″>No\
</SELECT></TD>\
<TD>$question<a href=\″/igotpain/$cgi_name/$help.html\″TARGET=\″reference\″>(help)</a></TD>\
\n″;
return($html);

}
sub addbody {

push(@body_lines, @_);

}
sub printtitle {

local ($title) = @_;
print ″<TITLE>$title</TITLE>″;

}
sub printbody {

print ″<BODY>″;
if ($debug) { print ″<PRE>″;}
print @body_lines;
if ($debug) {print ″</PRE>″;}
print ″</BODY>″;

}
sub printhtml {

print ″<HTML>\n″;
&printtitle(″$html_title″);
&printbody;
print ″</HTML>\n″;

}
sub printheader {

local ($cookie,$qlevel) = @_;
print ″Content-type: text/html\n″;
print ″Set-Cookie: $answercookiename=$cookie\n″;
print ″Set-Cookie: $levelcookiename=$qlevel\n″;
print ″\n″;

}

I claim:

1. A method of emulating human decision making, comprising:
(a) establishing a possibility set comprising a plurality of alternative possibilities, each having a distinguishing attribute;
(b) establishing a query set comprising a query;
(c) relating the query to each alternative in the possibility set using a set of primary bias values provided by an expert having knowledge of the alternatives, wherein each primary bias value is associated with a particular alternative, and reflects the expert's conception, based on the distinguishing attribute, of the relative degree of predictive value of the query for the particular alternative relative to other alternatives in the possibility set;
(d) obtaining a response to the query;
(e) determining, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set; and
(f) ranking the alternatives in the possibility set, based on the secondary bias values, to provide a decision comprising the set of alternatives, ranked according to likelihood.

2. The method of claim 1, wherein determining the set of secondary bias values involves increasing, decreasing or conserving the corresponding primary bias values based on the response to the query.

3. The method of claim 1, wherein the query set comprises a plurality of queries, and wherein ranking the alternatives in the possibility set involves summing and averaging of the primary or secondary bias values.

4. The method of claim 1, wherein determining a set of corresponding secondary bias values, and ranking the alternatives in the possibility set is achieved by using an ELICIT™ “Algorithm 42” core algorithm to process one or more of the primary or secondary bias values.

5. The method of claim 1, wherein the possibility set is a set of alternate medical diagnoses, wherein the expert is a medical expert, and wherein ranking the alternatives in the possibility set, based on the secondary bias values, provides a diagnosis comprising the set of alternate medical diagnoses, ranked according to likelihood.

6. A process for emulating human decision making on a computer having a processor and a storage device connected to the processor, comprising:
(a) configuring, in one or a plurality of electronic data bases stored in the storage device of the computer, a possibility set comprising a plurality of alternative possibilities, a query set comprising a query, and a set of primary bias values provided by an expert having knowledge of the alternatives, wherein each primary bias value is associated with a particular alternative, and reflects the expert's conception of the relative degree of predictive value of the query for the particular alternative relative to other alternatives in the possibility set;
(b) inputting a user's response to the query into the computer; and
(c) ranking, using a program stored on the storage device that is operative with the processor to receive and process the user's response, the set of alternative possibilities according to relative likelihood, based at least in part on the set of primary bias values, whereby a decision, comprising the set of ranked alternatives, is provided.

7. The process of claim 6, wherein ranking the set of alternative possibilities comprises querying the electronic data bases to determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set.

8. The process of claim 7, wherein determining the set of secondary bias values involves increasing, decreasing or conserving the corresponding primary bias values based on the response to the query.

9. The process of claim 7, wherein the query set comprises a plurality of queries, and wherein ranking the alternatives in the possibility set involves summing and averaging of the primary or secondary bias values.

10. The process of claim 7, wherein determining a set of corresponding secondary bias values, and ranking the alternatives in the possibility set is achieved by using an ELICIT™ “Algorithm 42” core algorithm to process one or more of the primary or secondary bias values.

11. The process of claim 6, wherein the possibility set is a set of alternate medical diagnoses, wherein the expert is a medical expert, and wherein ranking the alternatives in the possibility set, based on the primary bias values, provides a diagnosis comprising the set of alternate medical diagnoses, ranked according to likelihood.

12. A computer apparatus for facilitating emulation of human decision making, comprising:
(a) a computer comprising a processor and a storage device connected to the processor;
(b) a possibility set database stored on the storage device, wherein the possibility set database comprises a plurality of alternative possibilities;
(c) a query set database stored on the storage device, wherein the query set database comprises a query;
(d) a primary bias value data set stored on the storage device, wherein the primary bias values are provided by an expert having knowledge of the alternative possibilities, and wherein each primary bias value is associated with a particular alternative, and reflects the expert's conception of the relative degree of predictive value of the query for the particular alternative relative to other alternatives in the possibility set; and
(e) a program stored on the storage device for controlling the processor, wherein (i) the program is operative with the processor to receive a user's response to a query, (ii) determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set, (iii) rank the alternatives in the possibility set, based on the secondary bias values, to provide a decision comprising the set of alternative possibilities, ranked according to likelihood, and (iv) present the decision to the user.

13. The apparatus of claim 12, further comprising a user database stored on the storage device, wherein the program is operative with the processor to store user information in the user database, and update user information when new user information is received.

14. The apparatus of claim 12, wherein the program is farther operative with the processor to track user information.

15. A process for emulating human decision making over a wide-area network, comprising:
(a) configuring, in one or a plurality of electronic data bases of a server, a possibility set comprising a plurality of alternative possibilities, a query set comprising a query, and a set of primary bias values provided by an expert having knowledge of the alternatives, wherein each primary bias value is associated with a particular alternative, and reflects the expert's conception of the relative degree of predictive value of the query for the particular alternative relative to other alternatives in the possibility set;
(b) inputting a user's response to the query into a computer through a user subsystem;
(c) transmitting the user's response to the server over the wide-area network;
(d) ranking, using a program that is operative with a processor of the server to receive and process the user's response, the set of alternative possibilities according to relative likelihood, based at least in part on the set of primary bias values; and
(e) transmitting the ranked set of alternative possibilities to the user subsystem over the wide-area network, whereby a decision, comprising the set of ranked alternatives, is provided.

16. The process of claim 15, wherein ranking the set of alternative possibilities comprises querying the electronic data bases of the server to determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set.

17. The method of claim 16, wherein determining the set of secondary bias values involves increasing, decreasing or conserving the corresponding primary bias values based on the response to the query.

18. The method of claim 16, wherein the query set comprises a plurality of queries, and wherein ranking the alternatives in the possibility set involves summing and averaging of the primary or secondary bias values.

19. The process of claim 16, wherein determining a set of corresponding secondary bias values, and ranking the alternatives in the possibility set is achieved by using an ELICIT™ “Algorithm 42” core algorithm to process one or more of the primary or secondary bias values.

20. The process of claim 15, wherein the possibility set is a set of alternate medical diagnoses, wherein the expert is a medical expert, and wherein ranking the alternatives in the possibility set, based on the primary bias values, provides a diagnosis comprising the set of alternate medical diagnoses, ranked according to likelihood.

21. A computer network apparatus for facilitating emulation of human decision making, comprising:
(a) a server comprising a processor and a storage device connected to the processor;
(b) a possibility set database stored on the storage device, wherein the possibility set database comprises a plurality of alternative possibilities;
(c) a query set database stored on the storage device, wherein the query set database comprises a query;
(d) a primary bias value data set stored on the storage device, wherein the primary bias values are provided by an expert having knowledge of the alternative possibilities, and wherein each primary bias value is associated with a particular alternative, and reflects the expert's conception of the relative degree of predictive value of the query for the particular alternative relative to other alternatives in the possibility set; and
(e) a program stored on the storage device for controlling the processor, wherein (i) the program is operative with the processor to receive, from a user subsystem, a user's response to a query, (ii) determine, based on the response to the query and the set of primary bias values, a set of corresponding secondary bias values, wherein each secondary bias value is associated with a particular alternative, and reflects the expert's conception of the relative degree of predictive value of the query for the particular alternative relative to other alternatives in the possibility set, (iii) rank the alternatives in the possibility set, based on the secondary bias values, to provide a decision comprising the set of alternative possibilities, ranked according to likelihood, and (iv) transmit the decision to the user subsystem.

22. The apparatus of claim 21, further comprising a user database stored on the storage device, wherein the program is operative with the processor to store user information in the user database, and update user information when new user information is received.

23. The apparatus of claim 21, wherein the program is further operative with the processor to track user information.
